(19) United States
(12) Patent Application Publication
(10) Pub. No.: US 2026/0105832 A1
(43) Pub. Date: Apr. 16, 2026

(54) METHOD TO REDUCE FALSE WARNINGS OF ROAD SLIPPERY ALERT FUNCTION

(71) Applicant: Volvo Car Corporation, Göteborg (SE)

(72) Inventors: Derong YANG, Askim (SE); Per-Olof NILSSON, Göteborg (SE); Arun Shenbaga Priyan VIJAYAN, Göteborg (SE)

(73) Assignee: Volvo Car Corporation, Göteborg (SE)

(21) Appl. No.: 18/912,599

(22) Filed: Oct. 11, 2024

(51) Int. Cl. G08B 29/18; G08G 1/0967

(52) U.S. Cl. CPC G08B 29/185; G08G 1/0967

(57) ABSTRACT

According to an embodiment, disclosed is a system comprising one or more sensors, and a processor, wherein the processor storing instructions in a non-transitory memory that, when executed, cause the processor to, determine one or more of a probability of a road slippery condition at a geographic location and a confidence level on the probability using the sensors and in-vehicle road grip estimation module of a vehicle, receive a first weighting factor based on a first data from a road condition estimation module for the geographic location, receive a second weighting factor based on a second data from a climate module for the geographic location, determine an aggregate factor based on the first weighting factor, and the second weighting factor, and modify one or more of the probability of the road slippery condition and the confidence level on the probability based on the aggregate factor for the geographic location.

### FIELD OF THE INVENTION

The technical field generally relates to systems and methods for in-vehicle road slippery condition alert and more particularly related to systems and methods for reducing the false positive warnings generated by in-vehicle road slippery condition alert.

### BACKGROUND

The underlying state-of-the-art road friction estimation method relies on vehicle and tire motion sensors and models based on the applied tire forces. This model-based method can provide good resolution on the estimated road-tire adhesion coefficient. However, due to the complexity in the algorithm and dependencies on several vehicle and tire parameters and sensor signals, as well as the accuracy of the tire model, the estimate is quite sensitive. As a result, false positive warnings are inevitable and can be irritating to vehicle drivers.

Therefore, there is a need for a system and a method for reducing road slippery condition alerts which are false positives.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, disclosed is a system comprising, one or more sensors, and a processor; wherein the processor storing instructions in a non-transitory memory that, when executed, cause the processor to: determine one or more of a probability of a road slippery condition at a geographic location and a confidence level on the probability using the sensors and in-vehicle road grip estimation module of a vehicle; receive a first weighting factor based on a first data from a road condition estimation module for the geographic location; receive a second weighting factor based on a second data from a climate module for the geographic location; determine an aggregate factor based on the first weighting factor, and the second weighting factor; and modify one or more of the probability of the road slippery condition and the confidence level on the probability based on the aggregate factor for the geographic location.

According to an embodiment, disclosed is a method comprising, determining one or more of a probability of a road slippery condition at a geographic location and a confidence level on the probability using one or more sensors and in-vehicle road grip estimation module of a vehicle; receiving a first weighting factor based on a first data from a road condition estimation module for the geographic location; receiving a second weighting factor based on a second data from a climate module for the geographic location; determining an aggregate factor based on the first weighting factor, and the second weighting factor; and modifying one or more of the probability of the road slippery condition and the confidence level on the probability based on the aggregate factor for the geographic location.

According to an embodiment, disclosed is a non-transitory computer-readable medium having stored thereon instructions executable by a computer system to perform operations comprising determining one or more of a probability of a road slippery condition at a geographic location and a confidence level on the probability using one or more sensors and in-vehicle road grip estimation module of a vehicle; receiving a first weighting factor based on a first data from a road condition estimation module for the geographic location; receiving a second weighting factor based on a second data from a climate module for the geographic location; determining an aggregate factor based on the first weighting factor, and the second weighting factor; and modifying one or more of the probability of the road slippery condition and the confidence level on the probability based on the aggregate factor for the geographic location.

According to an embodiment, disclosed is a system comprising, a processor, wherein the processor storing instructions in a non-transitory memory that, when executed, cause the processor to determine one or more of a probability of a road slippery condition at a geographic location and a confidence level on the probability using an in-vehicle road grip estimation module; receive a first weighting factor based on a first data from road bump estimation module for the geographic location; receive a second weighting factor based on a second data from road damage estimation module for the geographic location; receive a third weighting factor based on a third data from road construction map module for the geographic location; receive a fourth weighting factor based on a fourth data from vehicle climate module for the geographic location; determine an aggregate factor based on the first weighting factor, the second weighting factor, the third weighting factor, the fourth weighting factor; and modify one or more of the probability of the road slippery condition and the confidence level on the probability based on the aggregate factor for the geographic location.

According to an embodiment, disclosed is a method comprising, determining one or more of a probability of a road slippery condition at a geographic location and a confidence level on the probability using an in-vehicle road grip estimation module; receiving a first weighting factor based on a first data from road bump estimation module for the geographic location; receiving a second weighting factor based on a second data from road damage estimation module for the geographic location; receiving a third weighting factor based on a third data from road construction map module for the geographic location; receiving a fourth weighting factor based on a fourth data from vehicle climate module for the geographic location; determining an aggregate factor based on the first weighting factor, the second weighting factor, the third weighting factor, the fourth weighting factor; and modifying one or more of the probability of the road slippery condition and the confidence level on the probability based on the aggregate factor for the geographic location.

According to an embodiment, disclosed is a non-transitory computer-readable medium having stored thereon instructions executable by a computer system to perform operations comprising determining one or more of a probability of a road slippery condition at a geographic location and a confidence level on the probability using an in-vehicle road grip estimation module; receiving a first weighting factor based on a first data from road bump estimation module for the geographic location; receiving a second weighting factor based on a second data from road damage estimation module for the geographic location; receiving a third weighting factor based on a third data from road construction map module for the geographic location; receiving a fourth weighting factor based on a fourth data from vehicle climate module for the geographic location; determining an aggregate factor based on the first weighting factor, the second weighting factor, the third weighting factor, the fourth weighting factor; and modifying one or more of the probability of the road slippery condition and the confidence level on the probability based on the aggregate factor for the geographic location.

### BRIEF DESCRIPTION OF THE FIGURES

These and other aspects of the present invention will now be described in more detail, with reference to the appended drawings showing exemplary embodiments of the present invention, in which:

FIG. 1 shows the block diagram of the system to reduce false positive warnings of road slippery alert function according to an embodiment.

FIG. 2 is an illustration of a vehicle with various sensors arranged strategically according to an embodiment.

FIG. 3 shows a block diagram of electronic components of a vehicle according to an embodiment.

FIG. 4 shows the road condition module and its components according to an embodiment.

FIG. 5 shows the architecture of the system to reduce false positive warnings of road slippery alert function according to an embodiment.

FIG. 6A shows vehicle conditions and driving behavior parameters according to an embodiment.

FIG. 6B shows a vehicle interacting with the Cloud to gather the crowdsourced data of a geographic location according to an embodiment.

FIG. 7 shows an example block diagram for an Artificial Intelligence and Machine Learning (AI/ML) model for reducing false positive warnings of road slippery alert function according to an embodiment.

FIG. 8A shows a structure of the neural network/machine learning model with a feedback loop according to an embodiment.

FIG. 8B shows a structure of the neural network/machine learning model with reinforcement learning according to an embodiment.

FIG. 8C shows a message that may be noted or displayed for the user according to an embodiment.

FIG. 9A shows a block diagram of the method executed by the vehicle to reduce false positive warnings of road slippery alert function according to an embodiment.

FIG. 9B shows a block diagram of the system of a vehicle to reduce false positive warnings of road slippery alert function according to an embodiment.

FIG. 9C shows a block diagram of the method executed by the non-transitory computer-readable medium to reduce false positive warnings of road slippery alert function according to an embodiment.

FIG. 10A shows a block diagram of the method executed by a vehicle to reduce false positive warnings of road slippery alert function according to an embodiment.

FIG. 10B shows a block diagram of the system of a vehicle to reduce false positive warnings of road slippery alert function according to an embodiment.

FIG. 10C shows a block diagram of the method executed by the non-transitory computer-readable medium to reduce false positive warnings of road slippery alert function according to an embodiment.

FIG. 11 shows the block diagram of the cyber security module in view of the system and server according to an embodiment.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general-purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the Cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome. ML models are also referred to as Artificial Intelligence (AI) model, Artificial Intelligence/Machine Learning (AI/ML) models, artificial intelligence algorithm, artificial intelligence (AI) engine, and artificial intelligence (AI) agent herein.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses etc. are examples of vehicles.

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle, and the second component can be an infrastructure that is enabled by a system of hardware, software, and firmware.

The term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module” (ECM), is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. Driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, Cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a Cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

As used herein the term “Road slippery condition” refers to the state of a roadway where the surface has reduced traction or grip, making it more difficult for vehicle tires to maintain contact and control. This condition can arise due to various factors such as ice, snow, rain, oil spills, or loose debris on the road surface, all of which can significantly impair vehicle handling and increase the risk of accidents. Equivalent terms for road slippery condition includes, for example, slippery road conditions, road slipperiness, reduced traction conditions, low traction road conditions, slick road conditions, icy road conditions, wet road conditions, slippery surface conditions, hazardous road conditions, and slippery pavement conditions. Each of these terms is used to describe situations where the road surface does not provide adequate friction for vehicle tires, leading to potential safety hazards.

As used herein, “road grip” refers to the frictional interaction between a vehicle's tires and the road surface, which is essential for maintaining control and stability during driving. It determines how effectively a vehicle can accelerate, decelerate, and maneuver. Equivalent terms for road grip include traction, tire adhesion, and tire-road friction. Road Slipperiness is a condition where the road surface provides reduced friction, leading to decreased tire grip and increased potential for vehicle skidding or loss of control. This condition can be caused by factors such as rain, ice, snow, oil spills, or loose gravel. Equivalent terms for road slipperiness include low traction, reduced road friction, and slippery road conditions.

As used herein, “probability” is a measure quantifying the likelihood that a particular event will occur. It is expressed as a number between 0 and 1, where 0 indicates that an event is impossible and 1 indicates that an event is certain. The probability of an event is often represented as a fraction, percentage, or decimal, providing a standardized way to express and calculate the chance of different outcomes. For example, consider the probability of road slipperiness. If weather conditions, such as rain, snow, and temperature, suggest a high chance of slipperiness, the probability might be 0.8 (or 80%). This indicates a strong likelihood that the road will be slippery. Conversely, if conditions are dry and the road surface is well-maintained, the probability might be as low as 0.1 (or 10%), indicating a minimal chance of slipperiness. Thus, probability provides a standardized way to express and calculate the chance of road conditions leading to slipperiness.

As used herein “confidence level” in probability refers to the statistical measure of certainty or reliability associated with an estimated probability. It quantifies the degree of confidence in the true probability of an event falling within a specified range or interval. The confidence level (often expressed as a percentage, such as 95% or 99%) indicates the probability that this calculated interval includes the true probability. For example, a 95% confidence level means that if one was to repeat the process of estimating the probability many times from different samples, one could expect the true probability to fall within the calculated confidence interval about 95% of the time. Consider two scenarios, where slipperiness is 100% with confidence of 50% versus slipperiness is 50% with confidence of 95%, Scenario 1 expresses certainty about the event (slipperiness), Scenario 2 offers a more reliable estimation of the probability of slipperiness, supported by a higher confidence level, making it the better choice for making informed decisions.

As used herein the term “Camera-Based Sensors” refers to sensors that utilize cameras as their primary sensing modality. These sensors incorporate camera technology to capture visual data, which is then processed and analyzed to extract relevant information. Camera-based sensors may further include additional components or functionalities beyond basic image capture, such as depth sensing, infrared imaging, or multispectral imaging. Camera-based sensors may encompass a variety of camera configurations and features tailored to specific monitoring tasks, such as road surface condition detection.

As used herein, “weighting factor” refers to a numerical value assigned to each item in a set of data to indicate its relative importance or contribution to a calculation, analysis, or decision-making process. Weighting factors are used to adjust the influence of different items or variables within a dataset based on their significance or relevance to a specific criterion or objective.

As used herein, an “aggregate factor” refers to a combined measure or index that results from aggregating or combining different weighting factors. This process involves integrating multiple weighted values into a single, comprehensive metric that reflects the overall impact or importance of various components within a dataset or system. For example, to assess road slipperiness, weighting factors are assigned as follows: road bump severity (30%), road damage extent (25%), road construction details (20%), and weather conditions (25%). For instance, if road bump severity scores 8 out of 10, road damage extent scores 6 out of 10, road construction details rate a smooth asphalt surface as 4 out of 5, and weather conditions rate heavy rain as 9 out of 10, the weighted contributions are computed as follows: 0.3×8/10=0.240 for road bump severity, 0.25×6/10=0.15 for road damage extent, 0.2×4/5=0.16 for road construction details, and 0.25×9/10=0.225 for weather conditions. Summing these contributions yields an overall slipperiness score of 0.24+0.15+0.16+0.225=0.775. This score indicates the level of potential slipperiness on the road segment, aiding in such things as decision-making for safety protocols, and travel advisories based on the aggregated assessment.

As used herein the term “monitoring” refers to systematic observation and assessment of a system, process, or environment in real-time or near real-time. It involves the regular collection, analysis, and interpretation of data using various sensors. Monitoring may be continuous or adaptive.

As used herein the term “adaptive monitoring” refers to an approach that dynamically adjusts its parameters, methods, or thresholds based on changing conditions, requirements, or feedback of the system. Unlike static monitoring systems with fixed configurations, adaptive monitoring systems have the ability to modify their behavior in response to evolving circumstances or user-defined criteria. For example, monitoring frequency may be changed based on remaining battery power, detected activity in the vehicle, road conditions, required accuracy, etc. Another example includes activating the sensors as needed.

The term “user” as used herein refers to any individual who is inside or on the vehicle (i.e., a communication system). Broadly it may encompass a user inside the vehicle. The terms occupant, passenger, person, may also be used interchangeably to refer to the user of the vehicle.

The term “vehicle system” or “system of a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being in a Cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

In today's car, the road slippery alert function is prevalent to provide low road grip warnings to the drivers in case of bad road weather conditions and thus the risk of losing control of the vehicle stability. The underlying state-of-the-art road friction estimation method relies on the vehicle and tire motion sensors and models based on the applied tire forces. This model-based method can provide good resolution on the estimated road-tire adhesion coefficient, however, due to the complexity in the algorithm and dependencies on a few vehicles and tire parameters and sensor signals, as well as tire model accuracy, the estimate is quite sensitive where false positive warnings are inevitable and can be irritating to the car drivers. Along with the high occurrence of false low friction warnings, the driver might start to ignore such warnings even if the tires are truly experiencing low friction. This will reduce the value of such connected safety functions, furthermore, deteriorate the vehicle safety and traffic safety.

The issue with false positive warnings in Original Equipment Manufacturer (OEM) road slippery alert systems arises when a severe road slippery condition warning is issued despite the absence of such conditions, which is undesirable.

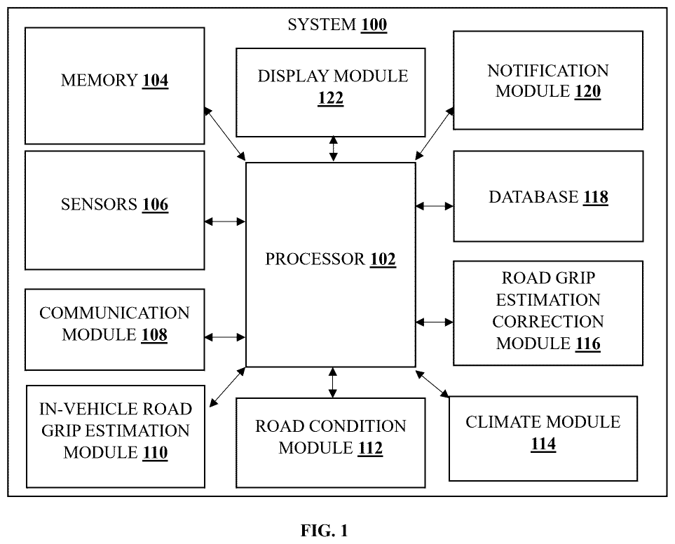

FIG. 1 shows the block diagram of the system to reduce false positive warnings of road slippery alert function according to an embodiment. The system 100 comprises a processor 102, memory 104, sensors 106, communication module 108, in-vehicle road grip estimation module 110, road condition module 112, climate module 114, road grip estimation correction module 116, database 118, notification module 120, and display module 122.

Processor 102: Processor may be a high-performance, multi-core CPU or system-on-chip (SoC) solution to process vast amounts of data from various sensors that may be used. Processor 102 processes data from sensors, such as cameras, LIDAR, radar, and other inputs to make real-time decisions, recommendations, and to execute control actions for the vehicle. Processor 102 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instructions. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, detect users, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. The processor interacts and exchanges data with one or more of the other components or modules of the system, for example, memory 104, sensors 106, communication module 108, in-vehicle road grip estimation module 110, road condition module 112, climate module 114, road grip estimation correction module 116, database 118, notification module 120, and display module 122.

Memory 104: Memory may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a Cloud-based memory. In another embodiment, the memory may be a local memory. In another embodiment, it may be a combination of local and Cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, Cloud-based memory relies on remote servers and services provided by third-party Cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and Cloud-based memory allows for flexible and efficient data management tailored to different needs of the system.

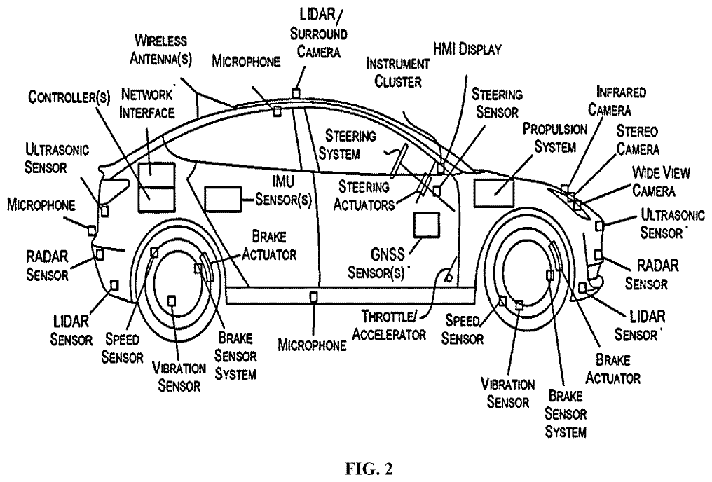

Sensors 106: FIG. 2 is an illustration of a vehicle with various sensors, actuators, and systems according to an embodiment. The system comprises various sensors, such as ultrasonic sensors, LIDAR sensors, radar sensors, camera-based sensors, infrared (IR) sensors, etc. FIG. 2 is depicted as an example system; neither is it limited by the systems depicted nor is it an exhaustive list of the sensors, actuators, and systems/subsystems, and/or features of the vehicle. Further, the vehicle shown should not be construed as limiting in terms of the arrangement of any of the sensors, actuators, and systems/subsystems depicted. These sensors, actuators, and systems/subsystems can be arranged as suited for a purpose to be performed by the vehicle. In case of autonomous vehicles, also known as self-driving vehicles or driverless vehicles, they can navigate and operate without human intervention. Sensors, for example, including cameras, camera-based sensors, LIDARs, radars, optical sensors, laser sensors, speed sensors, motion sensors, and ultrasonic sensors enable autonomous vehicles to detect and recognize objects, obstacles, and pedestrians on the road.

In an embodiment, sensors are activated to continuously monitor the surroundings and the road conditions. In an embodiment, sensors are activated to periodically monitor the surroundings and the road conditions.

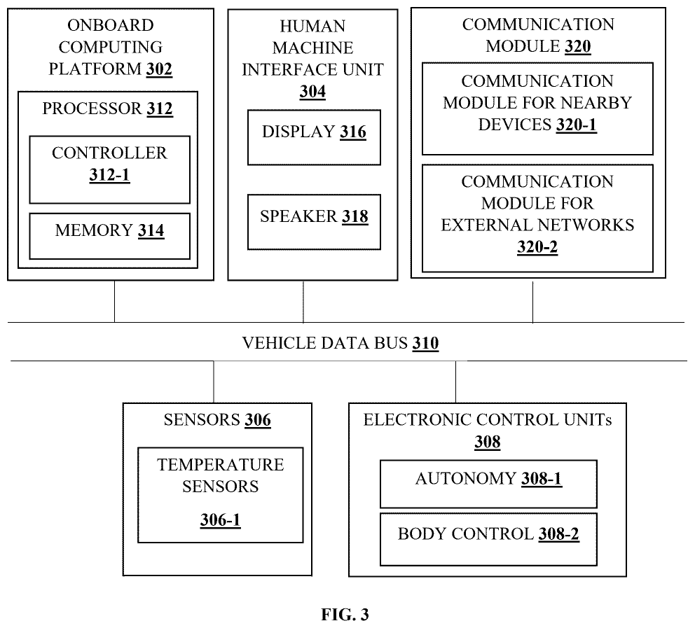

Communication module 108: Communication module facilitates communication between different modules within the system, communication between the vehicle and other devices, vehicle and other vehicles, vehicle and Cloud, and vehicle and other infrastructure components. FIG. 3 shows a block diagram of electronic components of a vehicle according to an embodiment. In the illustrated example, the electronic components comprise an onboard computing platform 302, a human-machine interface (HMI) unit 304, the communication module 320, sensors 306, electronic control units (ECUs) 308, and a vehicle data bus 310. FIG. 3 illustrates an example architecture of some of the electronic components as shown in FIG. 2. The onboard computing platform 302 comprises a processor 312 (also referred to as a microcontroller unit or a controller) and memory 314. In the illustrated example, processor 312 of the onboard computing platform 302 is structured to comprise the controller 312-1. In other examples, the controller 312-1 is incorporated into another ECU with its own processor and memory. The processor 312 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 314 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 314 comprises multiple kinds of memory, particularly volatile memory, and non-volatile memory. Memory 314 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of memory 314, the computer-readable medium, and/or within the processor 312 during execution of the instructions.

The HMI unit 304 provides an interface between the vehicle and a user. The HMI unit 304 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, a display 316 (e.g., a heads-up display, a center console display such as a liquid crystal display (LCD), an organic light emitting diode (OLED) display, a flat panel display, a solid-state display, etc.), and/or a speaker 318. For example, the display 316, the speaker 318, and/or other input and output device(s) of the HMI unit 304 are operable to emit an alert, such as an alert to request manual takeover to an operator (e.g., a driver) of the vehicle. Further, the HMI unit 304 of the illustrated example comprises hardware (e.g., a processor or controller, memory, storage, etc.) and software (e.g., an operating system, etc.) for an infotainment system that is presented via display 316.

Sensors 306 are arranged in and/or around the vehicle to monitor the interior regions of the vehicle and/or an environment in which the vehicle is driving. One or more of the sensors 306 may be mounted to measure various parameters around an exterior of the vehicle. Additionally, or alternatively, one or more of sensors 306 may be mounted inside a cabin of the vehicle or in a body of the vehicle (e.g., an engine compartment, wheel wells, etc.) to measure properties of the vehicle and/or interior sensing of the vehicle. For example, the sensors 306 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. Sensors may comprise temperature sensors 306-1 to measure the temperature around the vehicle.

The ECUs 308 monitor and control the subsystems of the vehicle. For example, the ECUs 308 are discrete sets of electronics that comprise their own circuit(s) (e.g., integrated circuits, microprocessors, memory, storage, etc.) and firmware, sensors, actuators, and/or mounting hardware. The ECUs 308 communicate and exchange information via a vehicle data bus (e.g., the vehicle data bus 310). Additionally, the ECUs 308 may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus 310.

In the illustrated example, the ECUs 308 comprise the autonomy unit 308-1 and a body control module 308-2. For example, the autonomy unit 308-1 is operable to perform autonomous and/or semi-autonomous driving maneuvers (e.g., defensive driving maneuvers) of the vehicle based upon, at least in part, instructions received from the controller 312-1 and/or data collected by the sensors 306 (e.g., object detection sensors). Further, the body control module 308-2 controls one or more subsystems throughout the vehicle, such as power windows, power locks, an immobilizer system, power mirrors, etc. For example, the body control module 308-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc.

The vehicle data bus 310 communicatively couples the communication module 320, the onboard computing platform 302, the HMI unit 304, the sensors 306, and the ECUs 308. In some examples, the vehicle data bus 310 comprises one or more data buses. The vehicle data bus 310 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

The communication module for nearby devices 320-1 is operable to communicate with other nearby communication devices. In an example, communication module 320 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, the communication module for external networks 320-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, the communication module 320-2 is operable to communicate with external networks. For example, the communication module 320-2 comprises hardware (e.g., processors, memory, storage, antenna, etc.) and software to control wired or wireless network interfaces. In the illustrated example, the communication module 320-2 comprises one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 320-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

The autonomy unit 308-1 of the illustrated example is operable to perform autonomous and/or semi-autonomous driving maneuvers, such as defensive driving maneuvers, for the vehicle. For example, the autonomy unit 308-1 performs the autonomous and/or semi-autonomous driving maneuvers based on data collected by the sensors 306. In some examples, the autonomy unit 308-1 is operable to operate a fully autonomous system, a park-assist system, an advanced driver-assistance system (ADAS), and/or other autonomous system(s) for the vehicle.

Further, in the illustrated example, controller (or control module) 312-1 is operable to monitor an ambient environment of the vehicle. For example, to enable the autonomy unit 308-1 to perform autonomous and/or semi-autonomous driving maneuvers, the controller 312-1 collects data that is collected by sensors 306 of the vehicle. In some examples, the controller 312-1 collects location-based data via the communication module 320 and/or another module (e.g., a GPS receiver) to facilitate the autonomy unit 308-1 in performing autonomous and/or semi-autonomous driving maneuvers. Additionally, the controller 312-1 collects data from (i) adjacent vehicle(s) via the communication module 320-1 and vehicle-to-vehicle (V2V) communication and/or (ii) roadside unit(s) via the communication module 320-2 and vehicle-to-infrastructure (V2I) communication to further facilitate the autonomy unit 308-1 in performing autonomous and/or semi-autonomous driving maneuvers.

In an embodiment, a connection is established between a vehicle and the user device. The user device is detected by exchanging handshaking signals. Handshaking is the automated process for negotiation of setting up a communication channel between entities. The processor sends a start signal through the communication channel in order to detect a user device. If the user device receives the signal, the processor may receive an acknowledgement signal from the user device. Upon receiving the acknowledgement signal, the processor establishes a secured connection with the user device. The processor may receive a signal at the communication module from the user device. The processor may further automatically determine the origin of the signal. The processor communicatively connects the communication module to the user device. Then the processor is operable to send and/or receive a message to and/or from the user device. The signals received by the communication module may be analyzed to identify the origin of the signal to determine the location of the user device.

In an embodiment, the system is enabled for bidirectional communication. The system or vehicle transmits a signal and then receives a signal/communication from an external device. As a first step, a data link between the vehicle and the external device is set up in order to permit data to be exchanged between the vehicle and the external device in the form of a bidirectional communication. This can take place, for example, via a radio link or a data cable. It is therefore possible for the external device to receive data from the vehicle or for the vehicle to request data from the external device. In an embodiment, bidirectional communication comprises the means for data acquisitions and are designed to exchange data bidirectionally with one another. In addition, at least the vehicle comprises the logical means for gathering the data and arranging it to a certain protocol based on the receiving entity's protocol. Initially, a data link for bidirectional communication is set up. The vehicle and the external device can communicate with one another via this data link and therefore request or exchange data, wherein the data link can be implemented, for example, as a cable link or radio link. Bidirectional communication has various advantages as described herein. In various embodiments, data is communicated and transferred at a suitable time interval, including, for example, 200 millisecond (ms) intervals, 100 ms intervals, 50 ms intervals, 20 ms intervals, 10 ms intervals, or even more frequent and/or in real-time or near real-time, in order to allow a vehicle to respond to, or otherwise react to, data. Bidirectional communication may be used to facilitate data exchange.

According to an embodiment, the communication module supports a communication protocol, wherein the communication protocol comprises at least one of a Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

In an embodiment, the system may comprise a cyber security module. In one aspect, a secure communication management (SCM) computer device for providing secure data connections is provided. The SCM computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system.

In an embodiment, the system may initially use certain sensors and identify more sensors to be activated that might be useful in sensing weather conditions, road conditions, or getting access to the required data from the Cloud, etc. In an embodiment, some sensors are active to constantly monitor, and some are activated as needed to reduce the battery power consumption.

In-vehicle road grip estimation module 110: Vehicles utilize advanced algorithms for in-vehicle road slippery condition estimation, primarily focusing on road grip estimation and friction between the tire and road. These algorithms integrate data from various sensors, such as wheel speed sensors, accelerometers, gyroscopes, and tire pressure monitors, to analyze and estimate road conditions in real-time.

The primary algorithm involves a model-based approach that calculates the road-tire adhesion coefficient, which is a measure of the friction between the tire and the road surface. This coefficient is estimated by analyzing the forces applied to the tires during vehicle motion. For example, when a tire experiences slip, the difference between the expected and actual wheel rotation speeds provides crucial data for the algorithm to determine the road's grip level. The model-based approach for road grip estimation in vehicles involves creating and utilizing mathematical models that represent the dynamic interactions between the tires and the road surface. These models are based on physical principles and empirical data, allowing for the estimation of the road-tire adhesion coefficient under various driving conditions.

In an embodiment, the data collection comes from: wheel speed sensors which measure the rotation speeds of all four wheels and differences in rotation speeds can indicate slip; accelerometers and gyroscopes that monitor the vehicle's acceleration, deceleration, and angular motion to detect changes in traction; a Tire Pressure Monitoring System (TPMS) which ensures tires are properly inflated, affecting their grip on the road; environmental sensors that collect data on external conditions such as temperature, moisture, and road surface texture.

The model-based approach estimates initial road grip by determining the road-tire adhesion coefficient using sensor data. This coefficient is a measure of the frictional force between the tires and the road surface, essential for understanding the road grip. The initial estimation is refined using a detailed tire model. This model accounts for various factors such as tire type, tread depth, and inflation level, which influence the road-tire interaction. Then using empirical models, the tire forces are estimated and thus the tire grip. For example, a common model is the Magic Formula, which describes the tire forces and moments as functions of slip ratio, camber angle, and other parameters.

The system then proceeds to calculate the probability of a slippery condition based on the adjusted road-tire adhesion coefficient. This involves statistical methods, to estimate the likelihood of slipperiness under current conditions, such as a Bayesian Inference method. The system may also calculate a confidence level for the estimated probability of slipperiness. This confidence level reflects the reliability of the data and the model.

For Example: Consider a vehicle driving on an icy road. The wheel speed sensors detect slight discrepancies in wheel rotation speeds, while accelerometers and gyroscopes indicate minor lateral motion, suggesting slip. The initial road-tire adhesion coefficient is calculated using these observations. The Magic Formula tire model adjusts this coefficient based on current tire and road conditions. The algorithm may then calculate a 60% probability of slipperiness with a confidence level of 80%, considering the consistency and quality of sensor data. This information is communicated to the driver through the vehicle's interface, warning them of the potential hazard.

There are many other in-vehicle technologies that are used or support the model-based estimation for road slipperiness alert or road grip alert to enhance driving safety. These technologies integrate data from different sources and employ various algorithms to provide real-time feedback to drivers and to assist vehicle systems. Some components and methods used by vehicle OEMs are:

Wheel Slip Detection: Vehicles use sensors to monitor wheel rotation speeds. By comparing the speed of each wheel, the system can detect differences that indicate slipping, which often occurs on slippery surfaces like ice or wet roads.

ABS and Traction Control Systems: Anti-lock Braking Systems (ABS) and Traction Control Systems (TCS) help in detecting and managing wheel slip. When these systems are activated, they can signal the presence of slippery conditions.

ESC (Electronic Stability Control): ESC uses sensors to monitor vehicle dynamics, including yaw rate, lateral acceleration, and steering angle. If the system detects that the vehicle is not responding as expected to driver inputs (e.g., understeering or oversteering), it can infer that the road may be slippery, and adjust braking and engine power to help maintain control.

Road Surface Information (RSI): A Road Surface Information system uses a combination of sensors and data analytics to assess road conditions. The system can gather data on factors like road texture, temperature, and moisture levels, then use this data to estimate slipperiness.

Connected Safety Systems: Volvo®'s vehicle-to-vehicle (V2V) and vehicle-to-infrastructure (V2I) communication technologies, where vehicles equipped with this technology can share real-time information about road conditions with each other and with road infrastructure. For instance, if one vehicle detects a slippery patch, it can broadcast this information to other vehicles in the vicinity.

Tire Pressure Monitoring System (TPMS): Proper tire pressure is critical for maintaining traction. TPMS alerts drivers to significant changes in tire pressure that could affect vehicle handling, indirectly helping to maintain optimal grip on the road.

Driver Assistance Systems: Advanced Driver Assistance Systems (ADAS), such as Adaptive Cruise Control (ACC) and Lane Keeping Assist (LKA), also help manage vehicle stability. These systems can make real-time adjustments to maintain safe driving conditions and can provide warnings or take corrective actions if slippery conditions are detected.

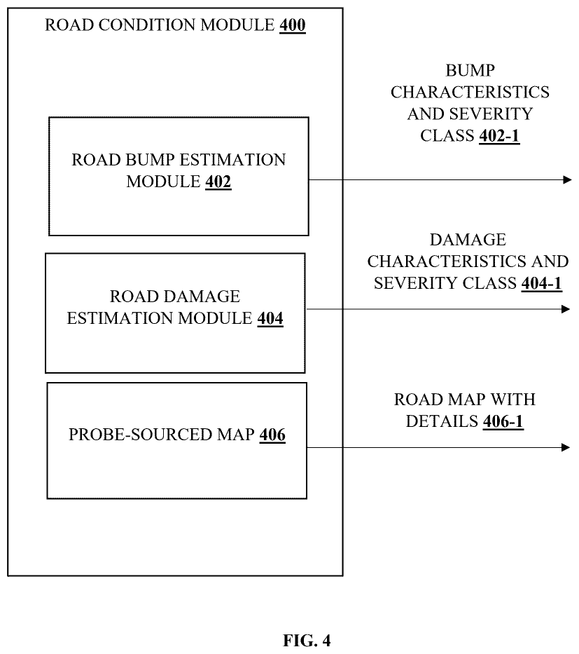

Road Condition module 112: FIG. 4 shows the road condition module and its components according to an embodiment. According to an embodiment, the system of the vehicle for acquiring detailed road condition data involves multiple specialized modules, each designed to detect and analyze specific types of road surface irregularities. Road condition module 400 may be used for detecting road bump details, road construction debris, road cracks and potholes, loose gravel, metal parts from the construction or otherwise etc. Each module utilizes a variety of sensors and technologies to gather and process data, providing real-time feedback on the road condition to the vehicle's systems and the driver.

Road Bump Estimation Module 402: Road Bump Estimation Module 402 considers input from accelerometers, suspension sensors, wheel speed sensors, cameras and LIDARs to determine bump characteristics and severity classes of the bumps.

Sensors present in the vehicle, for example, accelerometers measure vertical acceleration of the vehicle's body to detect sudden changes in elevation. Suspension sensors monitor the compression and rebound of the vehicle's suspension system. Wheel speed sensors may detect changes in wheel rotation speed that might indicate a bump. Cameras and LIDAR may measure the length and width of a bump. Inertial Measurement Unit (IMU) may combine data from sensors such as accelerometers and gyroscopes to accurately track the vehicle's motion and orientation.

Further, data fusion algorithms integrate data from multiple sensors to improve detection accuracy. The road bump estimation module provides output on estimated bump characteristics and severity of the bump/s based on its size, height, steepness or gradient, and spread of the bump/s. The severity class may be classified as low to high or between a range such as 0-1; 0-10; 0-100 based on a range assigned to a category, for example 0-2 being low, 3-7 being medium, and 8-10 being high. Severity class may be graded into more than three levels according to an embodiment. When a vehicle encounters a speed bump, the sensors (such as accelerometers, cameras, and LIDAR) detect and measure the relevant data points. The collected data is then processed using algorithms that classify the speed bump based on predefined thresholds for size, height, steepness, and spread and provide an output on bump characteristics and severity class 402-1. Notification to the driver about detected road bumps may be provided according to an embodiment.

Road Damage Estimation Module 404: Road damage estimation module 404 considers inputs from various sensors such as optical sensors, LIDARS, microphones, etc., and provides information on damage characteristics and severity class 404-1. Cameras (optical Sensors) may capture high-resolution images of the road surface, LIDAR (Light Detection and Ranging) scans the road surface to create detailed 3D maps of the road's topology, and microphones detect sound patterns associated with cracks or potholes, such as the noise made when driving over them.

For potholes, data may include the size (diameter), depth, shape, and location. The size is measured in centimeters or inches, the depth is gauged to understand the severity, and the shape, whether round or irregular, provides insights into the potential hazard. Location data, often acquired through GPS, indicates where the pothole is situated on the road, such as near the edge or in the center of the lane. For example, a pothole with a diameter of 40 centimeters, a depth of 12 centimeters, an irregular shape, and located in the center of the lane would be classified as a medium, deep, irregular-shaped hazard in a high-risk location and classified into a severity class of high. Similarly, the classification of road cracks involves measuring the length, width, depth, and pattern of the crack. Length is measured in meters or feet, width in millimeters or inches, and depth in centimeters or inches, all critical for determining the extent and severity of the crack. The pattern, whether linear, spider web, or block, helps in understanding the type and potential cause of the damage. For instance, a crack that is 5 meters long, 1 centimeter wide, 3 centimeters deep, and linear in pattern would be classified as an extensive, wide, moderately deep linear crack, indicating significant pavement deterioration. In similar ways other characteristics of the damage such as rutting, which is the deformation or grooves formed by repeated tire passage, edge cracking, etc., are also considered while providing damage class. In an embodiment, the potholes are cracks that may be inspected for retained wetness, water, snow, or spilled debris which may be enhancing the slipperiness of the potholes and cracks etc. For example, a spilled oil on the road or a pothole filled with water due to rain or snow and yet not dried, when traversed by vehicles may cause more slipperiness than the ones which are dry. Image Processing and Machine Learning modules would analyze camera images or other sensor data/fusion data to identify road damage and determine damage characteristics of size, shape, location, spread etc. parameters and severity class. A 3D mapping software may use LiDAR (Light Detection and Ranging) data to create detailed representations of road damage according to an embodiment. Further acoustic analysis may be performed of sound data to complement visual and LIDAR data for more accurate detection. The severity class may be classified as low to high or between a range such as 0-1; 0-10; 0-100 based on a range assigned to a category, for example 0-2 being low, 3-7 being medium, and 8-10 being high. Severity class may be graded into more than three levels according to an embodiment. In an embodiment, road damage alerts may be provided to inform the vehicle systems and the driver about the presence of cracks and potholes.

Probe Sourced Map Module 406: Probe sourced map module 406 creates a road map with details 406-1 of a location using crowdsourced data sourced from a group of vehicles using the vehicle probes (sensors). Crowdsourced data comprises one or more of GPS (Global Positioning System), weather data, construction details, traffic signals, line markings on the road, map of the road conditions, loose gravel, loose parts left on the road due to construction, diversions, temporary roads etc., which is shared by vehicles with the Cloud. For example, when driving over loose gravel, the Tire Pressure Monitoring System (TPMS) and microphones detect the characteristic drop in tire pressure and the distinct sound of gravel. Cameras and LIDAR provide visual confirmation. Pattern recognition algorithms process this data, and the system notifies the driver about the loose gravel and its location. Such data collected by vehicles is then sent to the Cloud. The data in the Cloud is aggregated and is used to create a map. This map can be sent back to the vehicles accessing the map via an application interface. GPS (Global Positioning System) provides precise location data for mapping road conditions and crowdsourced data comprises information/data from other connected vehicles and infrastructure. Further, V2X Communication (Vehicle-to-Everything) and/or V2I Communication (Vehicle-to-Infrastructure) enable data sharing between vehicles and infrastructure. In an embodiment, real-time maps display current road conditions, road signals, left over metal parts from construction sites, etc., including identified hazards, and provide predictive alerts and warnings about potential road hazards ahead based on historical data and real-time updates.

Crowdsourced data may not only comprise data from one or more vehicles, but it may further access data from the authorities like traffic stations, weather stations etc. according to an embodiment. According to an embodiment of the system, the system utilizes vehicle-to-infrastructure (V2I) communication to receive road condition updates from external sources, wherein the external sources comprise one or more of road sensors, and weather stations. According to an embodiment of the system, the processor is configured to factor in a time of day and traffic density effects on the probability of the road slippery condition and the confidence level on the probability. According to an embodiment of the system, the system utilizes crowdsourced data from multiple vehicles to refine an estimate of the road slippery condition in real-time.

Climate module 114: The Vehicle Climate Module in vehicles is a module designed to collect, analyze, and utilize real-time climate data. This module integrates data from onboard sensors, external weather services, GPS, mapping systems, and V2X communication. Onboard sensors continuously monitor immediate environmental conditions such as temperature, humidity, precipitation, and light levels, while the vehicle's GPS and mapping systems provide location and route information. This data may be sent to the Cloud and further the module retrieves real-time weather updates through weather Application Program Interface (APIs), including localized weather data relevant to the vehicle's path. V2X communication facilitates the exchange of weather updates and warnings from other vehicles and infrastructure.

Road grip estimation correction module 116: In-vehicle road slipperiness estimation technology employs several advanced systems to enhance driving safety by providing real-time feedback on road conditions. However, these systems generate false positive indications, erroneously identifying road conditions as slippery when they are not. Understanding the sources of these false positives is crucial for improving the accuracy and reliability of the technology.

Wheel slip detection relies on sensors that monitor wheel rotation speeds, detecting differences that indicate slipping. False positives in this model may arise from temporary changes in wheel speed due to uneven road surfaces, potholes, or debris. Sudden acceleration or deceleration, driving over loose gravel or sand, and mechanical issues such as a faulty sensor or wheel imbalance can also contribute to incorrect slip detection.

Anti-lock Braking Systems (ABS) and Traction Control Systems (TCS) are integral to detecting and managing wheel slip, but they can misinterpret sharp turns, aggressive braking or acceleration, and variations in tire pressure as indications of slippery conditions. Additionally, tire wear or mismatched tires may trigger false positives in these systems.

The Electronic Stability Control (ESC) system, which monitors vehicle dynamics, can overreact to normal driving maneuvers and classify them as loss of traction. Quick steering inputs, strong crosswinds, and inaccurate sensor readings due to calibration issues are common causes of false positives in ESC.

Road Surface Information (RSI) systems use sensors and data analytics to assess road conditions but can misclassify road texture or surface conditions. Reflections of sunlight on wet roads, sensor contamination (such as dirt, ice, or snow), and temperature fluctuations can lead to incorrect surface condition readings.

Connected Safety Systems, which share real-time road condition data between vehicles, can propagate false positives if a vehicle encountering temporary, non-slippery issues (e.g., a quick swerve) reports it as slippery. Network latency or data corruption during transmission can also contribute to incorrect information sharing.

Tire Pressure Monitoring Systems (TPMS) may suggest poor road conditions if they issue incorrect tire pressure alerts. Sensor errors, temperature changes affecting tire pressure readings, and faulty or uncalibrated sensors are typical reasons for these false positives.

Weather Data Integration systems, which use external weather data to predict road conditions, can produce false positives due to outdated or incorrect weather forecasts, rapid local weather changes not captured by the system, or inaccurate GPS positioning.

Advanced Driver Assistance Systems (ADAS), including Adaptive Cruise Control (ACC) and Lane Keeping Assist (LKA), might falsely indicate slippery conditions by misinterpreting normal vehicle dynamics as loss of traction. External factors such as road markings, signs, or shadows can lead to incorrect sensor readings.

Addressing these potential causes of false positives is necessary to enhance the reliability and accuracy of the road slipperiness estimation, for improving overall vehicle safety and driver confidence.

The problem that is to be solved is the false positive warnings present in the current Slippery Road Alert (SRA) function. As of today, the SRA function has generated a significant number of false warnings which induces customer complaints and distrust on this connected safety function which would otherwise be supposed to enhance the safety feeling of the customer. The false warnings are found to be frequent at certain types of road/traffic and weather conditions:
Construction sites, where speed bumps are often present
Rural gravel or obsolete roads, where road damages, e.g. cracks, potholes are often present
Roads with metal parts e.g. connection between two concrete plates
Sunny and dry weather with sufficiently high temperature

The present false warnings have been a problem since the introduction of the Road Slippery Alert function in the year 2015. No direct countermeasures are known in the prior art. In order to enhance the confidence of the warning, there are some filtering mechanisms e.g. to aggregate friction estimates from a number of vehicles under a certain time window, before a warning can be issued.

The past solutions are based on statistical methods, wherein the estimation of road friction is faulty by itself. According to an embodiment, a filtering method is used to get rid of the faulty estimates by scrutinizing a fleet of vehicles over a certain time frame.

According to an embodiment, the system implements a direct countermeasure for the identified root causes as specified herein. That is to say, the friction estimates from each vehicle are improved, which in the end contributes to a higher quality of data in the Cloud for the whole fleet. On the other hand, road irregularities and weather data from one vehicle can be shared through the Cloud to another vehicle so that the quality of the friction estimate in the other vehicle can be further enhanced.

To improve the road grip estimation accuracy and confidence, different modules which provide the information of road irregularities are provided. For instance, a LiDAR-based method in estimating several road irregularities features in P002214EP01. Volvo® Cars are also currently implementing vehicle motion and suspension-based methods in estimating road disturbances e.g. bumps and potholes.

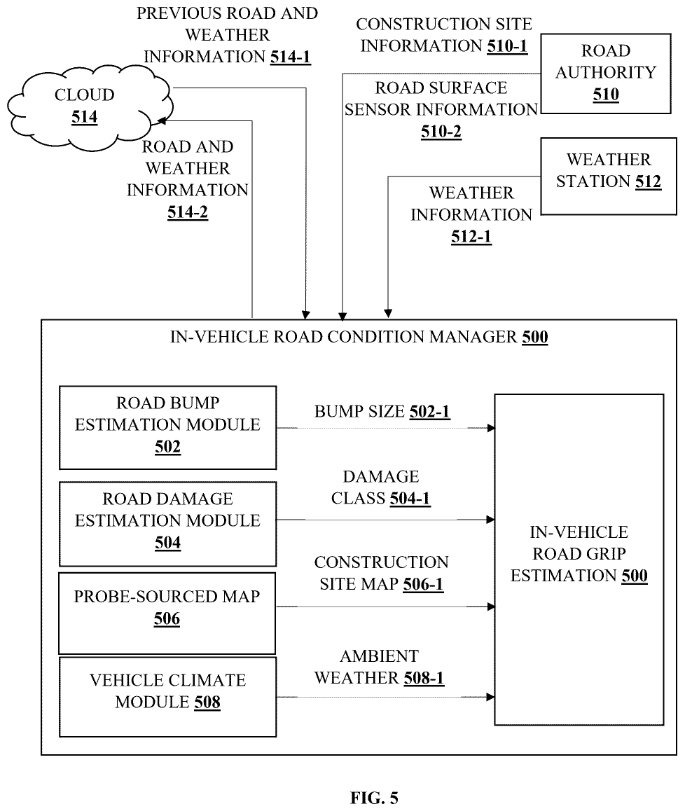

FIG. 5 shows the architecture of the system to reduce false positive warnings of road slippery alert function according to an embodiment. The architecture for the implementation comprises the data flow between the in-vehicle road condition manager 500 and the Cloud 514. The in-car Road Condition Manager is configured to fusion the information from four major sources.

Road bump estimation module 502 provides the bump size 502-1 information, if the bump size is over a certain threshold, it will set low confidence on the in-vehicle grip estimate and provide Cloud information to filter out slippery road alert warnings from other vehicles. That is to say, if this location on the friction map is detected with a sufficiently big bump, the confidence of the friction estimation at that location will be set low. This low confidence will further lower the weighting factor for the friction information estimated by other vehicles at similar locations, in this way, false slippery road warnings will be filtered out/canceled.

According to an embodiment of the system, the road bump estimation module, the road damage estimation module, and the road construction map module are located locally in the non-transitory memory of the vehicle or on a Cloud. According to an embodiment of the system, the road bump estimation module comprises information about a road bump detail from one or more other vehicles. According to an embodiment of the system, the road bump detail comprises one or more of bump size, number of bumps, and bump location.

Road damage estimation module 504 provides road damage class 504-1 information, e.g. cracks, potholes. If the damage class is high and exceeds a certain threshold, it will set low confidence on the in-vehicle grip estimate and provide Cloud information to filter out slippery road alert warnings from other vehicles. Similar data processing mechanism will be applied as in the road bump estimation module herein. This low confidence will further lower the weighting factor for the friction information estimated by other cars at similar locations, and in this way, false slippery road warnings will be filtered out/cancelled.

According to an embodiment of the system, the road damage estimation module comprises information about a road damage detail from one or more other vehicles. According to an embodiment of the system, the road damage detail comprises one or more of cracks, distribution of cracks, size and shape of cracks, potholes, distribution of potholes, size and shape of potholes.

Probe-sourced map 506 provides road construction site map 506-1/construction site information, which can complement the estimate from the road bump estimation module. Newly constructed roads usually have bumps and metal parts left on the road surface. That is to say, if the probe-sourced map provides “road construction site ongoing” information, the road bump estimation module will make use of this information, to enhance the confidence on the “bump detection”.

According to an embodiment of the system, the system further comprises incorporating data from external databases on road construction reports and road maintenance reports for an estimation of the road slippery condition.

Vehicle climate module 508 collects vehicle ambient weather 508-1 information e.g. temperature, humidity, direct sunlight (via ADAS camera fault report). If the combination factor of temperature, humidity and sunlight intensity is higher than a threshold, it will set low confidence on the in-vehicle grip estimate and provide Cloud 514 information to filter out slippery road alert warnings from other vehicles. Similar data processing mechanisms will be applied as in the road bump estimation module herein. This low confidence will further lower the weighting factor for the friction information estimated by other cars at similar locations, hence, false slippery road warnings will be filtered out/cancelled. Also, if the weather is cold and wet, it will set high confidence on the slippery road estimates.

Road Condition Manager is able to extract construction site information 510-1 directly from road authority 510, as well as the road surface sensor information 510-2 if the roads are embedded with temperature sensors. Weather stations 512 may also provide the weather information 512-1/road weather forecast information and fusion with the aforementioned signals from the vehicle climate module. According to an embodiment of the system, the road condition estimation module is located locally in the non-transitory memory of the vehicle or on a Cloud.

All the four modules described herein provide the estimates attached to a GPS location information for the vehicle, so that the signals from one single vehicle will be easily mapped to the road grip and weather information map in the Cloud 514. The system of the vehicle can send road and weather information 514-2 to the cloud and get the previous road and weather information 514-1 from Cloud 514.

Each of the modules mentioned herein will provide a weighting factor to modify the confidence of the road friction estimation. In the In-vehicle road grip estimation module, the weighting factors will be combined to generate an aggregated factor to affect the friction estimation confidence. For example, the friction estimation originally has got a confidence of 80% slippery road condition, then the aggregated factor from all four modules indicates that there is only 20% probability of slippery road, then the confidence of friction estimation will be lowered by multiplying 0.2, i.e., the confidence will be reduced to 64% which is (80%-80%*0.2).

According to an embodiment of the system, the road construction map module comprises information about a road construction detail from one or more of other vehicles, and one or more of road authority database, and road infrastructure database. According to an embodiment of the system, the road construction detail comprises one or more of metal parts, construction completion level, and loose gravel.

Weather Data Integration: The system further comprises integrating weather data from external sources to predict road conditions. By using GPS and weather forecasts, the vehicle can warn drivers of potential slippery conditions ahead based on current and predicted weather patterns.

According to an embodiment of the system, the climate module comprises information about a weather detail from one or more other vehicles. According to an embodiment of the system, the weather detail comprises temperature, humidity, sunlight intensity, cloud percent, and a first probability of rain, a second probability of snow, and a third probability of ice during a time period. According to an embodiment of the system, the climate module is located locally in the non-transitory memory of the vehicle or on a Cloud.

Referring to the architecture described in FIG. 5, the discussion centers on the fusion of information from four modules necessary for decision-making. This involves the integration of data from various sources to implement a rule-based approach. Specifically, if high temperatures are detected or road irregularities due to construction or poor conditions are identified, the system will lower the confidence level or assign less weight to severe road slippery alerts. Instead, it will give more credibility to estimations from other vehicles. This aggregation process utilizes data from multiple cars, not just one, to enhance the overall reliability of the system. Skeptical data points from individual vehicles are given less weight, while more trustworthy data from other vehicles are prioritized. This approach improves the future estimation and accuracy of road conditions.

Data analysis has shown that when there is a bump on the road, whether small due to minor irregularities or large, the wheel may momentarily lose contact with the ground. During these microseconds, the friction is low because the wheel is turning in the air, but this is not perceived by the driver as a slippery part of the road. A method of measuring vertical wheel movements allows for identifying these instances, thus lowering the confidence in these measurements. External data, such as weather forecasts or information about construction sites from traffic authorities, are also used to refine the accuracy and reliability of the road slipperiness estimation.

In an embodiment, the system utilizes the identified four types of information that will be filtered to assess severe road conditions. This information can originate from various sources, not just the vehicle's sensors. For example, construction site data can be obtained from the car's sensors, but also from authorities or a probe-sourced map. Multiple sources can be combined to provide accurate information about conditions such as rural gravel roads. If the roughness of the road indicates a gravel road with damage and potholes, this data can be sourced from different resources, confirming its accuracy. Similarly, temperature information can come from multiple sources.

A rule-based system is used to fuse this diverse data and produce a final assessment of road conditions. Examples of these rules include:
Temperature Rule: If the vehicle detects a high ambient temperature and the road sensors report minor irregularities, the system will lower the confidence in a severe slipperiness alert, prioritizing other vehicle estimations.

Construction Data Rule: If the vehicle receives construction site data from external sources such as traffic authorities, the confidence in road slipperiness alerts will be adjusted based on this external information.

Probe Vehicle Reports Rule: If multiple probe vehicles consistently report slippery conditions, the system will increase the confidence level of a slipperiness alert.

Road Type Rule: If the system identifies the road as a gravel road with confirmed damages from multiple sources, it will increase the probability of a slipperiness alert but may decrease confidence if conflicting data is present.

Example rules stated herein, and other rules framed in the system ensure that the system accurately assesses and adjusts the probability and confidence of road slipperiness alerts by integrating and weighing data from various sources. This approach reduces false positives and improves the reliability of the alerts provided to the driver.

Various rules can be formulated to address specific conditions. For instance, if a bump is detected, appropriate weightings and aggregations can be applied to the data, even though this may not be directly illustrated in current examples. Consider the climate model as an example. If the collected temperature data combined with other factors exceeds a certain threshold, the system will set a low confidence level on the in-vehicle grip estimation. This is refined by incorporating Cloud information. High detected temperatures will result in assigning less weight to the vehicle's data, thereby adjusting the system's confidence levels. Further the system would compute or determine the weighting between different modules and external data based on influence of the parameters on the road slipperiness condition.

Unlike prior art, which typically aggregates data from all vehicles using statistical methods in the Cloud, the current system incorporates additional features such as road irregularities, road bump data, road damage data, construction maps, and weather conditions etc. This multifaceted approach aims to decrease false warnings. The system now leverages newly available features, which are quantified, which were not accessible earlier, to enhance the accuracy of road slipperiness alerts. The inclusion of data from other sensors, such as suspension and LiDAR, highlights the system's improved capability to address previous limitations on not using the data to reduce the false positives. These additional features provide valuable information that helps solve the long-standing issue of false warnings. The advancement lies in the combination and utilization of these previously unavailable features. Technological advancements now allow these features to be estimated and shared with the Cloud, which are further used in addressing the old problem of false warnings with greater efficacy.

While estimating friction and sharing data with the Cloud as known in the prior art, leveraging these new features to solve the issue of false warnings was not solved and false warnings are still prevalent in OEM slipperiness alert function outputs. The integration of these additional features fundamentally enhances the system's ability to provide more accurate and more reliable road slipperiness alerts.

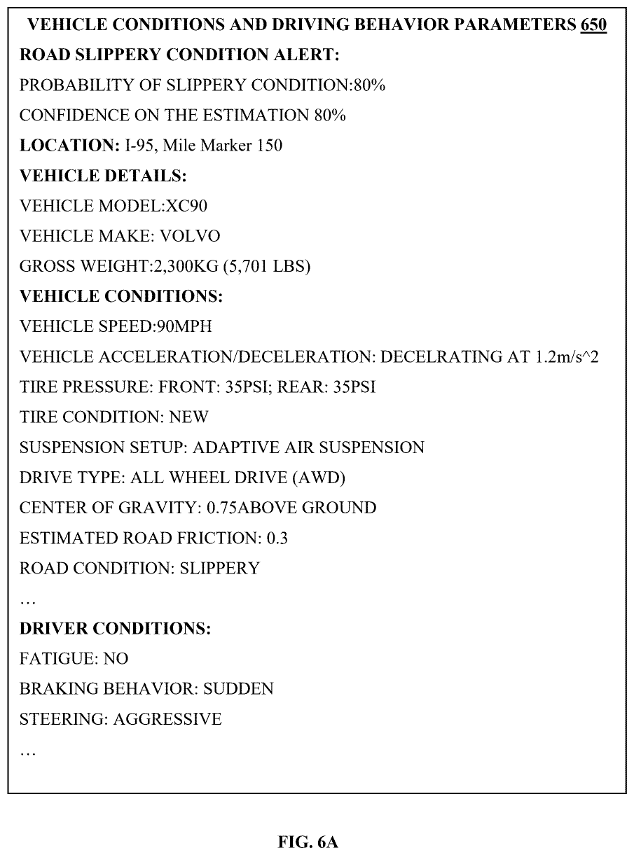

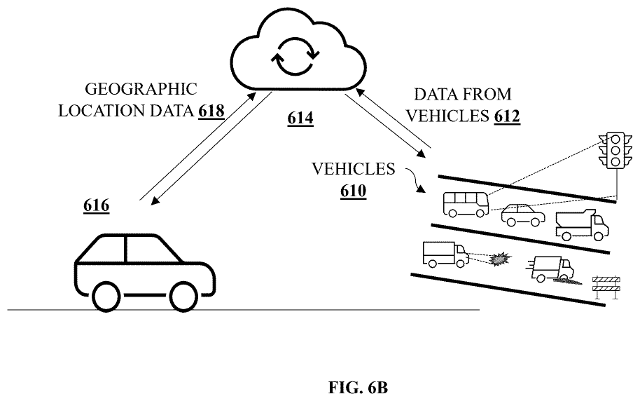

FIG. 6A shows vehicle conditions and driving behavior parameters according to an embodiment. Vehicle details, vehicle conditions, driver conditions are gathered along with road slippery alert predictions at a geographic location. These details may be, for example, as shown in FIG. 6A and may be referred to as vehicle conditions and driving behavior parameters.

Influence of vehicle conditions: Vehicle characteristics and conditions influence the measurement of road friction and vary based on the type and design of the vehicle, including parameters such as weight, tire condition, suspension setup, and drive type. For example, considering the weight of the vehicle, heavier vehicles like Sports Utility Vehicle (SUVs) and school vans exert greater force on the road surface, increasing contact pressure between the tires and pavement. This can enhance traction under certain conditions but may also lead to higher deformation of the tire, reducing its grip, especially on slippery surfaces. For example, a Volvo XC90 SUV weighing 2,300 kg will exhibit different friction characteristics compared to a lighter sports car weighing 1,500 kg, with the SUV potentially experiencing greater contact pressure but also higher deformation. Hence road slippery conditions alerts based on measurements are different to each class of vehicle and matching conditions of the vehicle within its class leads to better probabilities.

Type of vehicle also influences slipperiness alerts. SUVs and school vans are designed for stability and safety, featuring systems that support better grip and control on diverse surfaces. In contrast, sports cars, with their lower centers of gravity and high-performance tires, are optimized for high-speed handling but may perform differently on slippery surfaces. An SUV like the Volvo XC90, with its higher center of gravity and all-wheel drive system, will measure friction differently compared to a low-profile sports car with rear-wheel drive and, hence, their slipperiness alerts will be different.

Tire condition is another factor affecting traction. New tires with deeper treads provide better grip on wet or loose surfaces, while worn tires reduce the effective friction. Both, an SUV and a school van, may be equipped with all-season or winter tires, designed for varying conditions compared to the performance tires found on a sports car, which are typically less effective on slippery surfaces and hence their readings on friction and thus slipperiness alert output will differ.

The suspension setup impacts how the vehicle distributes its weight during maneuvers, influencing tire contact with the road. A well-tuned suspension maintains better tire contact, improving traction, whereas a poor suspension setup can lead to uneven weight distribution and reduced grip. For instance, an SUV with an adaptive air suspension which can dynamically adjust to road conditions would get the road conditions readings different than a sports car with a stiffer suspension setup.

Drive type, such as front-wheel drive, rear-wheel drive, or all-wheel drive, affects how power is distributed to the wheels, influencing traction. All-wheel drive systems generally offer better traction on slippery surfaces by distributing power to all wheels, reducing the likelihood of any single wheel slipping. The Volvo XC90 SUV, equipped with an all-wheel drive system, will exhibit different friction dynamics compared to a rear-wheel-drive sports car or a front-wheel-drive school van.

Influence of driver/driving behavior: Driver behavior conditions significantly influence the measurement of road friction and can vary based on factors such as speed, braking, and steering inputs. At higher speeds, the tires have less time to interact with the road surface, leading to a lower effective friction measurement due to reduced contact area, especially on slippery surfaces. Conversely, at slower speeds, the tires maintain better contact with the road, resulting in a higher measured friction coefficient. Therefore, a driver maintaining a steady, moderate speed is likely to experience more consistent and accurate friction measurements, while a speeding driver may encounter reduced traction and lower friction readings.

Braking behavior also impacts friction measurement. Sudden or hard braking can cause wheel lockup in non-ABS vehicles or frequent ABS activation, both of which temporarily reduce tire-road contact and skew friction measurements. Gradual and controlled braking, on the other hand, allows for better tire-road interaction, leading to more accurate friction measurements. Consequently, drivers who use smooth and gradual braking techniques are likely to obtain more reliable friction readings compared to those who brake abruptly.

Steering inputs are another critical factor. Smooth and gradual steering maintains consistent tire contact with the road, providing more stable friction measurements. Aggressive steering can cause the tires to lose grip, decreasing the measured friction. Therefore, drivers who employ gentle steering adjustments are more likely to achieve stable friction readings, while those making sharp or sudden turns may observe fluctuating and lower friction values.

Acceleration behavior also plays a role in friction measurement. Rapid acceleration can cause wheel spin, reducing tire-road contact and resulting in lower friction measurements. Slow and steady acceleration helps maintain tire grip, providing higher and more accurate friction measurements.

Driver behavior, including maintaining moderate speeds, using gradual braking and steering inputs, and accelerating smoothly, enhances the accuracy of friction measurements. Abrupt or aggressive driving actions can lower the measured friction and reduce the vehicle's ability to maintain traction, demonstrating the significant influence of driver conditions on the evaluation of road slipperiness.

The aforementioned description of parameters or the list provided in FIG. 6A serves as an illustrative example and is not comprehensive. The parameters that influence the friction between the road and the tire indirectly contribute to slipperiness alerts. Therefore, any vehicle or driver characteristic that affects friction and consequently the road slipperiness condition should be considered as part of the list, even if it is not explicitly mentioned in FIG. 6A.

According to an embodiment of the system, the system further comprises a vehicle detail, wherein the vehicle detail comprises one or more of a brand, model, a make, and a weight class category of the vehicle. According to an embodiment of the system, the system further considers a vehicle operating detail to determine the probability and the confidence level, wherein the vehicle operating detail comprises one or more of a speed, an acceleration or deceleration, a steering wheel position, and a brake force. According to an embodiment of the system, the system further considers a driver behavior data to determine the probability and the confidence level, wherein the driver behavior data comprises an acceleration pattern, a braking pattern, a reaction time, and a steering behavior.

FIG. 6B shows a vehicle interacting with the Cloud to gather the crowdsourced data of a geographic location according to an embodiment.

According to an embodiment of the system, one or more vehicles 610 collect data via a sensor or a component responsible for collecting specific data. The data may be specific to the geographic location and is tagged to the location for example, potholes, cracks, construction details etc. Some of the details, for example construction details may also be cross verified or gathered from construction authority websites or databases.

In an embodiment, the vehicles 610 may upload the data from vehicles 612 comprising data on road bump data, road damage, probe-sourced map data and vehicle climate module data and road grip estimation. It may further comprise a comprehensive set on vehicle conditions, driver or driving behavior, and slipperiness alert along with the vehicle characteristics such as make, model, drive type etc., corresponding to each of these vehicles. Some of the vehicle characteristics may also be obtained based on the vehicle model from an OEM website or database. The data from the vehicles 612 is sent to Cloud 614. In an embodiment, a part of the collected information may be sent to the Cloud. For example, data as shown in the FIG. 6A or a sub part of the information.

Any other vehicle, such as 616 may use the information corresponding to the geographic location 618 either by querying or by connecting while at/near the geographic location. The data may be used for filtering or reducing the false slippery alerts in the vehicle 616.

The system within the vehicle may comprise a processor comprising one or more machine learning models configured to filter out the data on false slippery alerts based on the in-vehicle sensed data and the data from the vehicle 612 accessed through the Cloud 614. In an embodiment, the Cloud may comprise of other applications which may process the data and provide the analytics.

The filtering method may be a rule-based system or AI/ML based method.

### Rule Based System:

A rule-based system for evaluating road slipperiness in vehicles utilizes a structured approach to integrate and analyze diverse data sources, including road bump information, road damage reports, weather conditions, and probe-sourced maps. This system assigns specific weightings to various parameters based on predefined rules, enhancing the accuracy and reliability of slipperiness estimations. For instance, significant road bumps and severe weather conditions are given high weights, while minor damages and inconsistent reports receive lower weights. Additionally, the system employs cross-validation rules to filter out false positives by cross-referencing data from multiple sources. For example, if heavy rains promote multiple probe vehicles to consistently report slipperiness, the confidence in the estimation increases. Conversely, conflicting data or minor road issues result in decreased confidence and adjusted probabilities. By dynamically adjusting weightings and confidence levels, the rule-based system provides a nuanced and accurate assessment of road slipperiness, enhancing driver safety and decision-making.

### Example Rules

### Road Bump Information:

Rule 1: If the road bump height is greater than 10 cm and the steepness is over 15 degrees, assign a high weight of 0.8.

Rule 2: If the road bump height is between 5 cm and 10 cm with steepness between 10 and 15 degrees, assign a moderate weight of 0.5.

Rule 3: If the road bump height is less than 5 cm and the steepness is less than 10 degrees, assign a low weight of 0.2.

Rule 4: If a bump is detected at speeds below 20 km/h, reduce the weight by 50% as it is less likely to impact slipperiness significantly.

### Road Damage Information:

Rule 5: If a pothole has a diameter greater than 20 cm and a depth exceeding 10 cm, assign a high weight of 0.9.

Rule 6: If a crack is wider than 2 cm and longer than 1 meter, assign a high weight of 0.7.

Rule 7: For medium-sized damage (10-20 cm diameter potholes, 1-2 cm wide cracks), assign a moderate weight of 0.5.

Rule 8: For minor damage (potholes less than 10 cm in diameter, cracks less than 1 cm wide), assign a low weight of 0.3.

Rule 9: Cross-check recent vehicle data to validate reported damage and if consistent, increase the weight by 0.1.

### Probe-Sourced Map Information:

Rule 10: If more than five probe vehicles report slipperiness in the same location within the last 10 minutes, assign a high weight of 0.8.

Rule 11: If slipperiness is reported by 2-5 probes, assign a moderate weight of 0.5.

Rule 12: If slipperiness is reported by fewer than two probes, assign a low weight of 0.2.

Rule 13: If the reports from probe vehicles show inconsistencies with known road conditions, reduce the weight by 0.3.

### Weather Information:

Rule 14: If heavy rain or snow is detected, assign a high weight of 0.9.

Rule 15: If light rain or fog is present, assign a moderate weight of 0.5.

Rule 16: For clear weather conditions, assign a low weight of 0.2.

Rule 17: Compare Cloud-sourced weather data with in-vehicle sensors; if they match, increase the weight by 0.1. If they do not match, decrease the weight by 0.2.

Rule 18: If there is a sudden drop in temperature below freezing, assign an additional weight of 0.3.

### Cross-Validation Rules:

Rule 19: If data from multiple sources encountering road bumps, road damage, probes, and weather consistently indicate slipperiness, increase the confidence level by 0.2.

Rule 20: If conflicting data is detected (e.g., in-vehicle sensors detect dry conditions while probes report slipperiness), reduce the confidence level by 0.3 and flag for further analysis.

Rule 21: If historical data indicates frequent false positives in a specific area, reduce the weight for that area's data by 0.2.

Though simple rules have been presented here, the rules can be formed with interactions of parameters within the module or interactions with other parameters from other modules.

Estimation from In-Vehicle Road Slipperiness Alert System:

Without the application of the current rule-based system on various factors, the estimation of road slipperiness would be based solely on raw data without consideration of weightings or cross-validation.

Initial Probability of Road Slipperiness: 50%

Initial Confidence Level: Medium (50%)

### Applying Rule-Based System:

For example, consider that only a minor road bump and road damage are sensed by the vehicle sensors and the system classifies them as follows:

### Road Bump Information:

Rule 2: Moderate weight for bump (0.5)

Adjusted Probability Contribution: −10% (This means the initial probability decreases by 10% in its estimation due to the presence of a road bump.)

Adjusted Confidence: −10% (Confidence decreases by 10%)

Weighting factor 1=0.5

### Road Damage Information:

Rule 8: Low weight for minor pothole (0.3)

Adjusted Probability Contribution: 0% (No change in the probability due to the presence of minor road damage (pothole).)

Adjusted Confidence: −5% Confidence decreases by 5% based on the reliability of detecting minor road damage

Weighting factor 2=0.8

Final Estimation after Applying Rules:

To calculate the final probability of road slipperiness and confidence level:

$$\begin{matrix}Final Probability of Road Slipperiness = Initial slipperiness + \\ \begin{matrix}( weighing factor 1 ) \\ ( \begin{matrix}decrease the initial value by \\ 10 \% due to road bump\end{matrix} )\end{matrix} \\ = 50 \% - 0.8 ( 10 \% of 50 ) \\ = 50 \% - 4 \% \\ = 46 \%\end{matrix}$$

$$\begin{matrix}Final Confidence Level = Initial confidence level + \\ \begin{matrix}( weighing factor 1 ) \\ ( \begin{matrix}decrease the initial value \\ by 5 \% due to road bump\end{matrix} )\end{matrix} + \\ \begin{matrix}( weighing factor 1 ) \\ ( \begin{matrix}decrease the initial probability \\ by 5 \% due to potholes\end{matrix} )\end{matrix} \\ = 50 \% - 0.8 ( 10 \% of 50 ) - 0.5 ( 5 \% of 50 ) \\ = 50 \% - 4 \% - 1.25 \% \\ = 43.75 \%\end{matrix}$$

The overall probability and the confidence on the probability has been decreased which means that the presence of potholes, cracks, speed bumps etc., is what is making the original in-vehicle grip estimation detect slipperiness, and the current system adjusted one or more of the probability and the confidence on the probability of the slipperiness as intended by incorporating the added aggregate factor.

Though simple rules are illustrated, complex rules with various interactions can be coded into the rule-based system. Further, though road bump and road damage information are utilized, the probability and/or the confidence can be changed based on the information provided from the one or more of the four modules.

In general, the final estimates would be:

Final Probability of Road Slipperiness: (initial estimation)+(road bump weighing factor) (% change in initial estimated value)+(road damage weighing factor) (% change in initial estimated value)+(weather weighing factor) (% change in initial estimated value)+(probe data weighing factor) (% change in initial estimated value)−(cross-validation weighing factor) (% change in initial estimated value)

Final Confidence Level: (initial estimation)+(road bump weighing factor) (% change in initial estimated value)+(road damage weighing factor) (% change in initial estimated value)+(weather weighing factor) (% change in initial estimated value)+(probe data weighing factor) (% change in initial estimated value)−(cross-validation weighing factor) (% change in initial estimated value)

According to an embodiment of the system, the probability is in a first range between 0 to 100 percent or in a second range between 0-1.0. According to an embodiment of the system, the confidence level is in a first range between 0 to 100 percent or in a second range between 0-1.0. According to an embodiment of the system, the aggregate factor is in a third range between 0-1.0.

### AI/ML Models:

In an embodiment, Artificial Intelligence (AI) and Machine Learning (ML) methods may be used to improve the accuracy and reliability of in-vehicle road grip probability and confidence estimates by integrating and analyzing various factors such as road bumps, road damage, weather conditions, and probe-sourced maps information as explained herein. One effective approach involves the use of supervised learning algorithms, such as decision trees, random forests, and gradient boosting machines, which can be trained on historical data to predict road slipperiness based on the input parameters. These algorithms can learn complex relationships between the various factors and their impact on road grip, enabling the system to make accurate predictions.

In an embodiment, ensemble learning techniques, which combine the predictions of multiple models to improve accuracy, may be particularly beneficial. For instance, a random forest model can aggregate the outputs of multiple decision trees, each trained on different subsets of data, to provide a robust estimate of road slipperiness. Gradient boosting machines can sequentially build models that correct the errors of previous models, further enhancing predictive performance.

In an embodiment, unsupervised learning methods, such as clustering algorithms, may be employed to identify patterns and anomalies in the data. For example, clustering algorithms can group similar road conditions and weather patterns, helping to detect outliers and reduce false positives in slipperiness alerts.

In an embodiment, Deep learning techniques, such as convolutional neural networks (CNNs) and recurrent neural networks (RNNs), may be utilized to process and analyze large volumes of data from various sensors and sources. CNNs can effectively handle spatial data, such as images of road conditions, while RNNs are well-suited for time-series data, such as weather patterns and probe vehicle reports over time. These neural networks can learn intricate patterns and dependencies in the data, providing highly accurate predictions.

In an embodiment, reinforcement learning can be employed to continuously improve the system's performance through trial and error. By receiving feedback from real-world driving scenarios, the system can adapt and optimize its predictions over time, ensuring that it remains accurate and reliable under varying conditions.

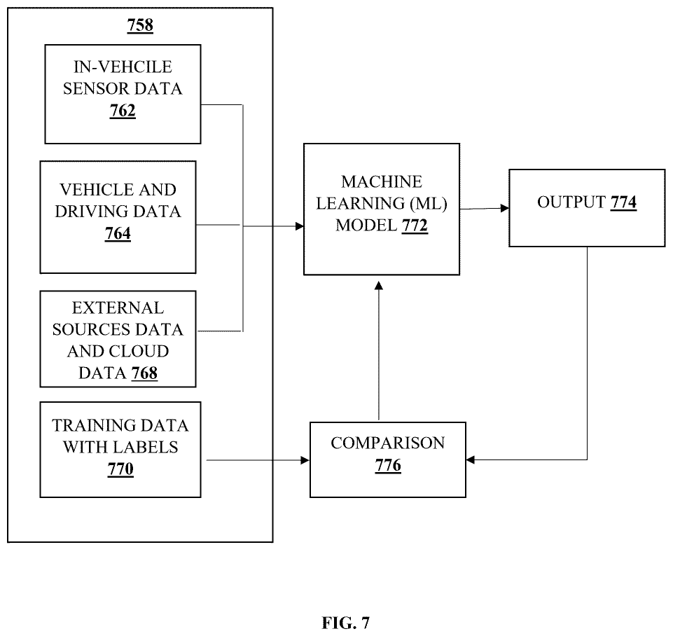

FIG. 7 shows an example block diagram for an Artificial Intelligence and Machine Learning (AI/ML) model for reducing false positive warnings of road slippery alert function according to an embodiment. The machine learning model 772 may take as input from in-vehicle sensor data 762. It may comprise data from vehicle systems on road bump characteristics, road damage characteristics, road damage class, construction site maps, weather data sensed by the vehicle sensors etc., as explained in FIG. 4 and FIG. 5.

The training data sample may also comprise vehicle and driving data 764 relating to the vehicle and the driving. This may comprise, for example, vehicle weight, speed, braking style, steering input data, driver behavior such as fatigue etc., as explained in FIG. 6A.

External sources data and weather data 768 may comprise data derived from crowdsourcing data, from other vehicles, from weather authorities, road authorities, etc. as explained in FIG. 5 and FIG. 6B.

Any of the aforementioned types of data (e.g., in-vehicle sensor data 762, vehicle and driving data 764, external sources data and weather data 768) may correlate or form a pattern of inputs and the corresponding output 774 which is a probability and/or confidence score adjustment values, percentages, weights on the in-vehicle road grip estimation. Such correlations/patterns between inputs and outputs may be automatically learned by the machine learning model 772. In an embodiment, during training, the machine learning model 772 may process the training data sample (e.g., in-vehicle sensor data 762, vehicle and driving data 764, External sources data and weather data 768) and based on the current parameters of the machine learning model 772, predict output 774 which is a probability and/or confidence score adjustment for values, percentages, weights on the in-vehicle road grip estimation.

In an embodiment, the real-time sensor data may be processed using one or more machine learning models 772, trained and based on similar types of data to correctly predict an adjustment for a given data. For example, comparison 776 may be based on a loss function that measures a difference between the predicted/detected output and the training data with labels 770. Based on the comparison at 776 or the corresponding output of the loss function, a training algorithm may update the parameters of the machine learning model 772, with the objective of minimizing the differences or loss between subsequent predicted output 774 and the corresponding labels 770. By iteratively training in this manner, the machine learning model 772 may “learn” from the different training data samples and become better at predicting output 774. In an embodiment, the machine learning model 772 is trained using a data class which is specific to a vehicle for which the model is predicting adjustments, that is, if the vehicle is an SUV, the data from the Cloud is considered for an SUV of similar weight and speed class and also under similar driving conditions. In an embodiment, the machine learning model 772 is trained using data which is general to the vehicle types and is used for predicting probability and/or confidence score adjustment values, percentages, weights on the in-vehicle road grip estimation. In an embodiment, each data element from the in-vehicle sensor data 762, vehicle and driving data 764, external sources data and weather data 768 may be given weights provided as inputs to the AI/ML system.

Through training, the machine learning model 772 may learn to identify predictive and non-predictive features and apply the appropriate weights to the features to optimize detecting accuracy and predictive accuracy of the machine learning model 772. In embodiments where supervised learning is used and each training data sample 758 has a label 770, the training algorithm may iteratively process each training data sample 758 (e.g., in-vehicle sensor data 762, vehicle and driving data 764, external sources data and weather data 768) and generate a predicted output 774 which involves probability and/or confidence score adjustment values, percentages, weights on the in-vehicle road grip estimation. Based on the comparison 776 results, the training algorithm may adjust machine learning model 772 parameters/configurations (e.g., weights) accordingly to minimize the differences between the generated predicted output 774 and the corresponding labels 770. Any suitable machine learning model and training algorithm may be used, including, e.g., neural networks, decision trees, clustering algorithms, and any other suitable machine learning techniques. Once trained, the machine learning model 772 may take input data and predict output 774 which is probability and/or confidence score adjustment values, percentages, weights on the in-vehicle road grip estimation. In an embodiment, the machine learning model, 772 is an artificial neural networks (ANN) model.

According to an embodiment of the system, the system further comprises one or more machine learning models aided by artificial intelligence. According to an embodiment of the system, the machine learning models classify the road slippery condition based on one or more of vehicle parameters, wherein the vehicle parameters comprise one or more of a weight category, a tire tread, a tire width, a tire radius, a tread pattern, a tread depth, a tire pressure, a wheelbase, a suspension system, a braking force, a steering angle, a throttle position, and a drive type. According to an embodiment of the system, the machine learning models are trained on historical data comprising road condition data, weather data, one or more of vehicle parameters, and driver behavior data. According to an embodiment of the system, the machine learning models are configured to continuously learn, and update as new data is collected, improving an accuracy of an estimate of the road slippery condition over time through adaptive algorithms.

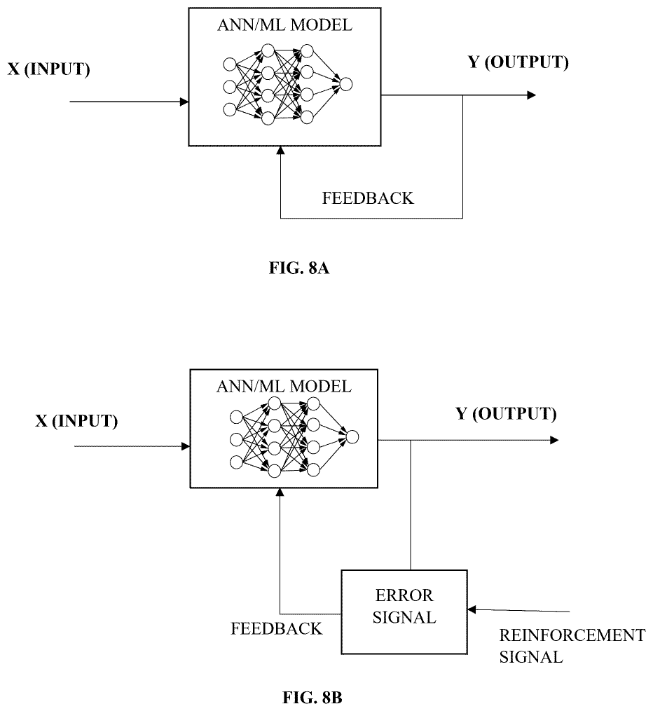

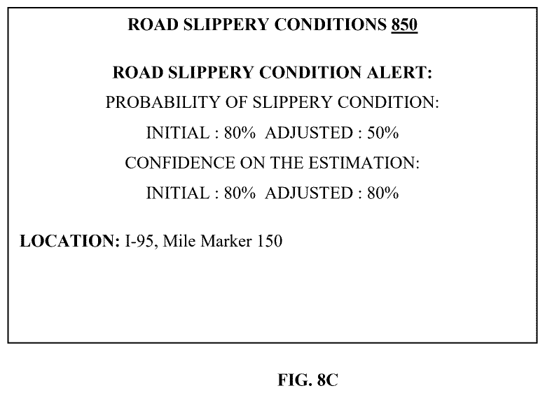

FIG. 8A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data 758 comprises in-vehicle sensor data 762, vehicle and driving data 764, external sources data and weather data 768, and output data 774 may comprise a probability and/or confidence score adjustment values, percentages, weights on the in-vehicle road grip estimation. The model may learn from the data. Learning can be supervised learning and/or unsupervised learning and may be based on different scenarios and with different datasets. Supervised learning comprises logic which uses at least one of a decision tree, logistic regression, and support vector machines. Unsupervised learning comprises logic which uses at least one of a k-means clustering, a hierarchical clustering, a hidden Markov model, and an apriori algorithm. The output layer may be probability and/or confidence score adjustment values, percentages, weights on the in-vehicle road grip estimation based on the inputs which may be in-vehicle sensor data 762, vehicle and driving data 764, external sources data and weather data 768, and the previous output data 774.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the models' performance may decline while adding new, unlabeled input due to many reasons which include, but not limited to, concept drift, recall precision degradation due to drifting away from true positives, and data drift over time. A feedback loop in the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of road bumps, weather conditions, road damage information, construction details etc. for different vehicle weight classes under similar road conditions and similar driving behavior, etc.) are used that are meant for the model to learn how and what adjustments need to be performed on probability or confidence in the probability along with the weightage to be provided from each influencing factor. Afterward, the model is tested using unlabeled data. By using, for example, deep learning and neural networks, the model can then make predictions on whether the desired output (e.g., whether the road slippery condition probability and confidence is adjusted such that it is not a false positive indication anymore as from the original in-house road grip estimation etc.) is in the predicted accuracy level. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically.

FIG. 8B shows a structure of the neural network/machine learning model with reinforcement learning according to an embodiment. The network receives feedback from authorized networked environments. Though the feedback logic is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

Database 118: The system stores various types of data that can be stored in a database for processing, analysis, and future reference. In an embodiment, it may store the data for service providers. Data comprises raw data captured by the in-vehicle sensors, data about the vehicle and driving characteristics, geographic location, weather data, estimated in-vehicle road grip adjustment, predicted values on adjustment factors on probability of the estimation and the confidence on the estimation, etc., all these values may be stored in the database 118. The data or part of the data may be uploaded to the Cloud for other vehicle's reference.

Notification module 120: Notification module may notify the user of the initial estimations and adjustments to the initial estimations. FIG. 8C shows a message that may be noted or displayed for the user according to an embodiment. The notification about slippery road conditions 850 comprising initial and adjusted estimations of probability and confidence on the probability may be sent to an external device or may be displayed on an infotainment system according to an embodiment. The notification module, for providing users with road slipperiness alerts, is designed to deliver timely and accurate information regarding driving conditions. This module integrates with the vehicle's onboard systems and the central AI/ML processing unit to receive real-time data on road conditions, including road bumps, road damage, weather, and probe-sourced information. Upon determining a high probability of road slipperiness, the module utilizes a combination of visual, auditory, and haptic feedback to alert the driver. Visual alerts may appear on the dashboard or heads-up display, prominently indicating the slippery condition and advising caution. Auditory alerts can include warning chimes or spoken messages to ensure the driver's attention. Additionally, haptic feedback, such as vibrations through the steering wheel, can provide a tactile warning. The notification module ensures that alerts are clear and easily interpretable, providing actionable information without overwhelming the driver. By delivering these alerts promptly, the system enhances driver awareness and safety, enabling informed decisions to mitigate risks associated with slippery road conditions. According to an embodiment of the system, the system is configured to send alerts to a driver of the vehicle about the road slippery condition prompting the driver to take precautionary measures.

Display module 122: Display module 122, in the vehicles may be connected to the notification module 120 through the vehicle's onboard computer or electronic control unit (ECU) according to an embodiment. Any message sent to the display module by the notification module is presented to the user on the vehicle's infotainment system, displayed and/or via a speaker, or sent to a user's personal device. The connection between notification module 120 and the display module 122 is established through a communication network within the vehicle. Modern vehicles use Controller Area Network (CAN) or other communication protocols to transmit data between different electronic components, including the alert system and the display module.

Once the signal reaches the display module, it activates the appropriate visual and audible alerts to inform the users. In another embodiment, the display module may also generate pop-up alerts on the infotainment or navigation screen. Furthermore, the vehicle may be equipped with haptic feedback capabilities, the display module 122 can trigger haptic alerts, such as gentle vibrations in the seat, to provide an additional tactile cue to the user.

In an embodiment, the system comprises on-edge computing units and temporary memory. On-edge computing units refers to hardware components installed within the vehicle that are responsible for processing data locally, without relying on external servers or Cloud services. This unit typically comprises a specialized computer or microcontroller with sufficient processing power and memory to perform computations in real-time. Its function is to execute algorithms and analyze data collected by the system's sensors, cameras, and other input devices. Temporary memory, also known as volatile memory or RAM (Random Access Memory), is a type of computer memory that temporarily stores data and instructions that the CPU (Central Processing Unit) needs to access quickly. On-edge computing in the context of road slipperiness alert systems may be used due to its ability to process data locally on the vehicle, ensuring rapid and efficient analysis of real-time conditions. By performing computations on-edge, the system can immediately integrate data from various sensors, including road bumps, road damage, weather conditions, and probe-sourced information, without the latency associated with Cloud-based processing. This immediacy can be useful to provide timely alerts and can impact a driver's response to hazardous conditions. Moreover, on-edge computing enhances reliability by reducing dependence on continuous internet connectivity, which can be intermittent or unavailable in certain driving environments. It also ensures data privacy and security by keeping sensitive information within the vehicle's ecosystem. The decentralized nature of on-edge computing distributes the processing load, optimizing the system's overall performance and resilience. Consequently, on-edge computing is integral to delivering fast, reliable, and secure road slipperiness alerts, thereby improving driving safety and decision-making in real-time.

In some implementations, the user devices and the vehicle may be associated with a notification platform. In some implementations, the one or more sensors may communicate with the user device of the driver, a vehicle control system of the vehicle, the user device of the passenger, the notification platform, and/or the like.

User device comprises one or more devices capable of receiving, generating, storing, processing, and/or providing information, such as information described herein. For example, user device may comprise a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user devices may receive information from and/or transmit information to notification platforms and/or server devices. User device may comprise an Application Software Interface (API) that integrates with the system.

In some implementations, as shown, the notification platform may be hosted in a Cloud computing environment. Notably, while implementations described herein describe notification platform as being hosted in a Cloud computing environment, in some implementations, notification platform may be non-Cloud-based (i.e., may be implemented outside of a Cloud computing environment) or may be partially Cloud-based.

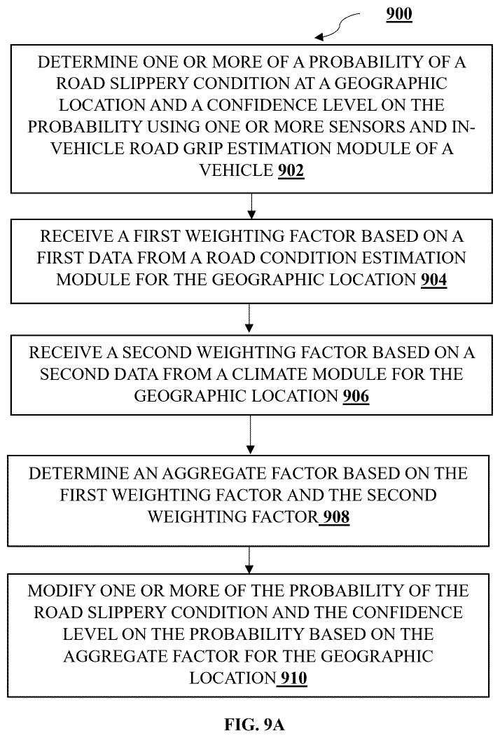

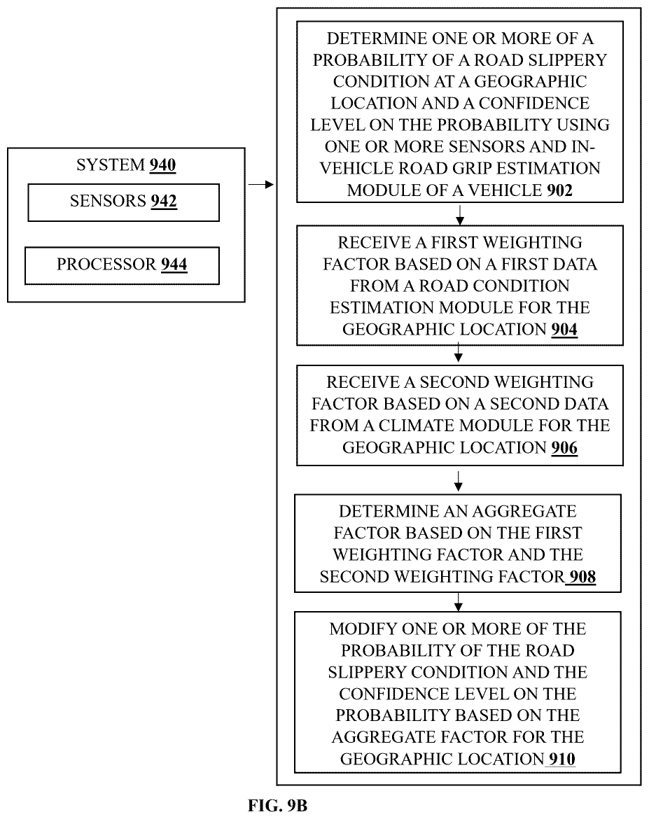

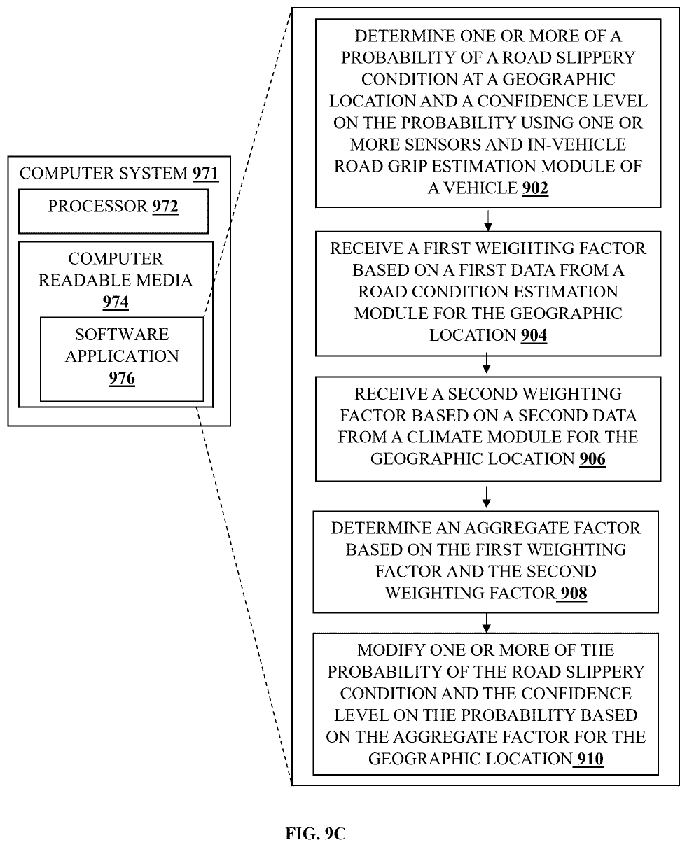

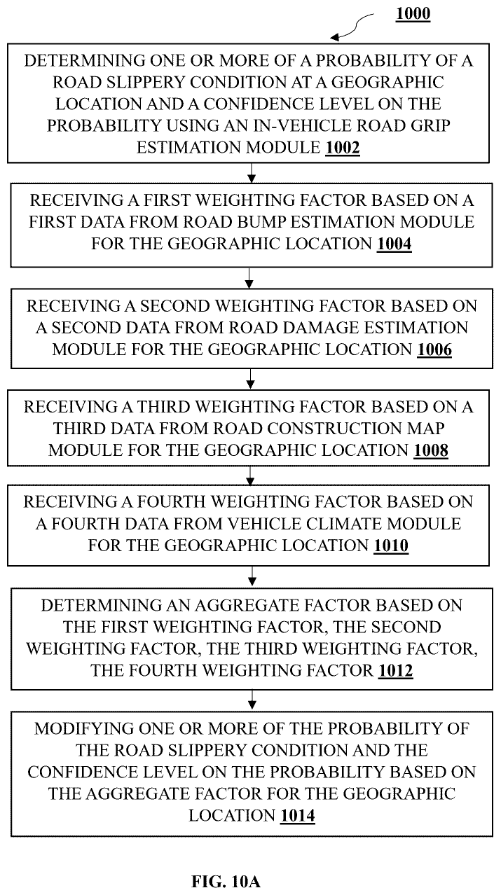

FIG. 9A shows a block diagram of the method executed by the vehicle to reduce false positive warnings of road slippery alert function according to an embodiment. According to an embodiment, disclosed is a method 900 comprising, determining one or more of a probability of a road slippery condition at a geographic location and a confidence level on the probability using one or more sensors and in-vehicle road grip estimation module of a vehicle at step 902; receiving a first weighting factor based on a first data from a road condition estimation module for the geographic location at step 904; receiving a second weighting factor based on a second data from a climate module for the geographic location at step 906; determining an aggregate factor based on the first weighting factor, and the second weighting factor at step 908; and modifying one or more of the probability of the road slippery condition and the confidence level on the probability based on the aggregate factor for the geographic location at step 910.

According to an embodiment of the method, the method integrates with vehicle navigation systems to suggest alternative routes based on a current road slippery condition and a predicted road slippery condition. According to an embodiment of the method, the method further employs on-edge computing to perform initial data processing locally on the vehicle, reducing latency and improving real-time response. According to an embodiment of the method, the method is configured to integrate with smartphone applications to provide drivers with notifications and alerts about road conditions before they start their journey. According to an embodiment of the method, the method comprises a rule-based system for determining the individual module factors and the aggregate factor.

FIG. 9B shows a block diagram of the system of a vehicle to reduce false positive warnings of road slippery alert function according to an embodiment. According to an embodiment, disclosed is a system 940 comprising, one or more sensors 942, and a processor 944; wherein the processor storing instructions in a non-transitory memory that, when executed, cause the processor to: determine one or more of a probability of a road slippery condition at a geographic location and a confidence level on the probability using the sensors and in-vehicle road grip estimation module of a vehicle at step 902; receive a first weighting factor based on a first data from a road condition estimation module for the geographic location at step 904; receive a second weighting factor based on a second data from a climate module for the geographic location at step 906; determine an aggregate factor based on the first weighting factor, and the second weighting factor at step 908; and modify one or more of the probability of the road slippery condition and the confidence level on the probability, based on the aggregate factor for the geographic location at step 910.

According to an embodiment of the system, the road condition estimation module comprises a road bump estimation module, a road damage estimation module, and a road construction map module. According to an embodiment of the system, the first data is based on third data from the road bump estimation module, a fourth data from the road damage estimation module, and a fifth data from the road construction map module for the geographic location.

According to an embodiment of the system, the confidence level is determined based on a variance and a consistency of the first data and the second data. According to an embodiment of the system, the system is further configured to communicate with one or more of a Cloud or other vehicles via a vehicle-to-vehicle (V2V) communication network to share information about the road slippery condition.

According to an embodiment of the system, the processor is configured to update the probability of the road slippery condition, and the confidence level as new data is received in real-time.

According to an embodiment of the system, the geographic location is determined using Global Positioning System (GPS).

According to an embodiment of the system, the system further utilizes road gradient and curvature information to determine the road slippery condition.

FIG. 9C shows a block diagram of the method executed by the non-transitory computer-readable medium to reduce false positive warnings of road slippery alert function according to an embodiment. According to an embodiment, disclosed is a non-transitory computer-readable medium 974 having stored thereon instructions executable by a computer system 971 to perform operations comprising determining one or more of a probability of a road slippery condition at a geographic location and a confidence level on the probability using one or more sensors and in-vehicle road grip estimation module of a vehicle at step 902; receiving a first weighting factor based on a first data from a road condition estimation module for the geographic location at step 904; receiving a second weighting factor based on a second data from a climate module for the geographic location at step 906; determining an aggregate factor based on the first weighting factor, and the second weighting factor at step 908; and modifying one or more of the probability of the road slippery condition and the confidence level on the probability based on the aggregate factor for the geographic location at step 910. A software application 976 may be stored on the computer-readable medium 974 and executed by a processor 972 of the computer system 971.

According to an embodiment of the non-transitory computer-readable medium, the instructions further comprise displaying the road slippery condition on a display. According to an embodiment of the non-transitory computer-readable medium, the instructions further comprise displaying an alternate route on the display to avoid a slippery road.

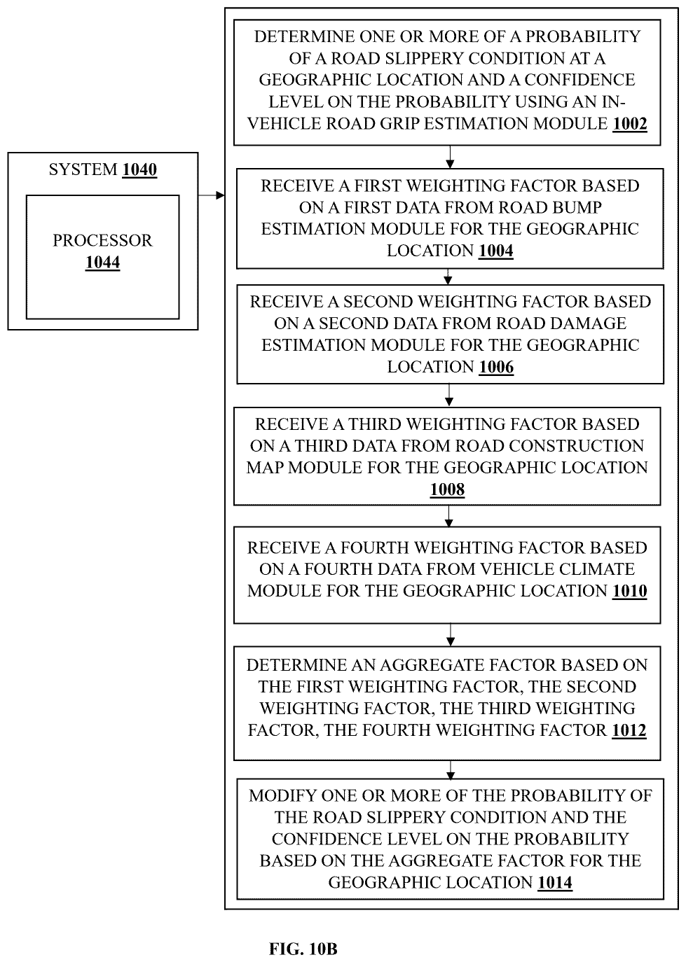

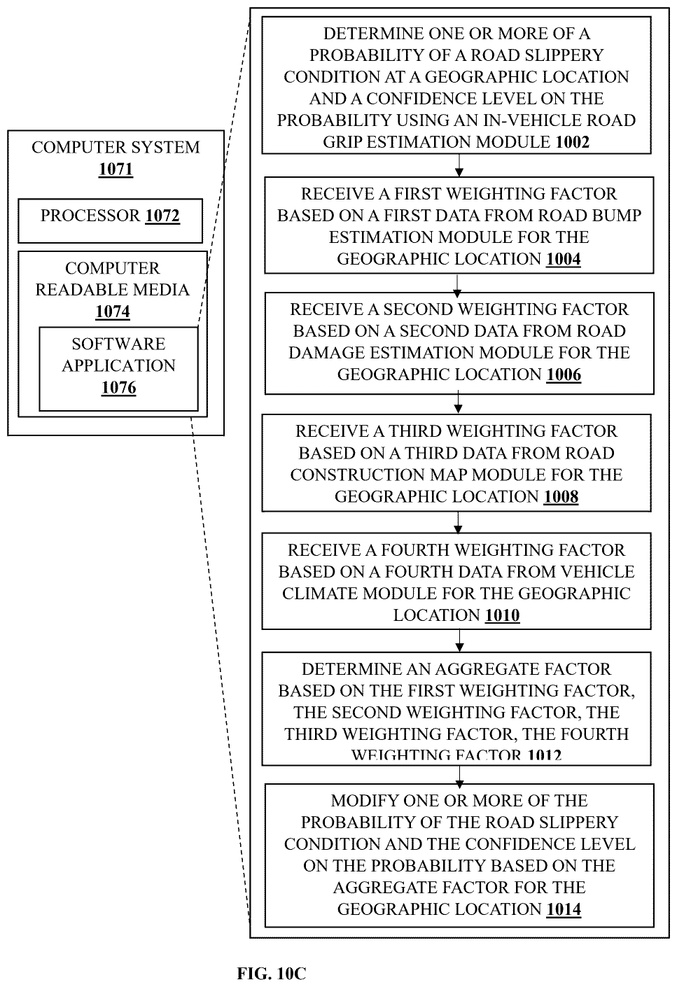

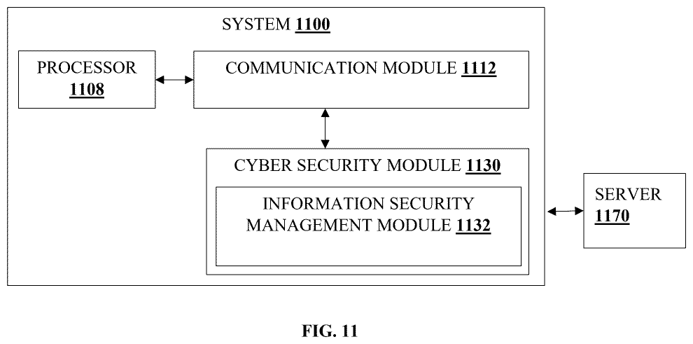

FIG. 10A shows a block diagram of the method executed by the vehicle to reduce false positive warnings of road slippery alert function according to an embodiment. According to an embodiment, disclosed is a method 1000 comprising, determining one or more of a probability of a road slippery condition at a geographic location and a confidence level on the probability using an in-vehicle road grip estimation module at step 1002; receiving a first weighting factor based on a first data from road bump estimation module for the geographic location at step 1004; receiving a second weighting factor based on a second data from road damage estimation module for the geographic location at step 1006; receiving a third weighting factor based on a third data from road construction map module for the geographic location at step 1008; receiving a fourth weighting factor based on a fourth data from the vehicle climate module for the geographic location at step 1010; determining an aggregate factor based on the first weighting factor, the second weighting factor, the third weighting factor, the fourth weighting factor at step 1012; and modifying one or more of the probability of the road slippery condition and the confidence level on the probability, based on the aggregate factor for the geographic location at step 1014.

According to an embodiment of the method, the system utilizes crowdsourced data from multiple vehicles to refine an estimate of the road slippery condition in real-time. According to an embodiment of the method, the system utilizes a rule-based system to determine the aggregate factor.

FIG. 10B shows a block diagram of the system of a vehicle to reduce false positive warnings of road slippery alert function according to an embodiment. According to an embodiment, disclosed is a system 1040 comprising, a processor 1044, wherein the processor storing instructions in a non-transitory memory that, when executed, cause the processor to determine one or more of a probability of a road slippery condition at a geographic location and a confidence level on the probability using an in-vehicle road grip estimation module at step 1002; receive a first weighting factor based on a first data from road bump estimation module for the geographic location at step 1004; receive a second weighting factor based on a second data from road damage estimation module for the geographic location at step 1006; receive a third weighting factor based on a third data from road construction map module for the geographic location at step 1008; receive a fourth weighting factor based on a fourth data from vehicle climate module for the geographic location at step 1010; determine an aggregate factor based on the first weighting factor, the second weighting factor, the third weighting factor, the fourth weighting factor at step 1012; and modify one or more of the probability of the road slippery condition and the confidence level on the probability based on the aggregate factor for the geographic location at step 1014.

According to an embodiment of the system, the system utilizes crowdsourced data from multiple vehicles to refine an estimate of the road slippery condition in real-time. According to an embodiment of the system, the system utilizes a rule-based system to determine the aggregate factor.

FIG. 10C shows a block diagram of the method executed by the non-transitory computer-readable medium to reduce false positive warnings of road slippery alert function according to an embodiment. According to an embodiment, disclosed is a non-transitory computer-readable medium 1074 having stored thereon instructions executable by a computer system to perform operations comprising determining one or more of a probability of a road slippery condition at a geographic location and a confidence level on the probability using an in-vehicle road grip estimation module at step 1002; receiving a first weighting factor based on a first data from road bump estimation module for the geographic location at step 1004; receiving a second weighting factor based on a second data from road damage estimation module for the geographic location at step 1006; receiving a third weighting factor based on a third data from road construction map module for the geographic location at step 1008; receiving a fourth weighting factor based on a fourth data from vehicle climate module for the geographic location at step 1010; determining an aggregate factor based on the first weighting factor, the second weighting factor, the third weighting factor, the fourth weighting factor at step 1012; and modifying one or more of the probability of the road slippery condition and the confidence level on the probability based on the aggregate factor for the geographic location at step 1014. A software application 1076 may be stored on the computer-readable medium 1074 and executed by a processor 1072 of the computer system 1071.

According to an embodiment of the non-transitory computer-readable medium, the system utilizes crowdsourced data from multiple vehicles to refine an estimate of the road slippery condition in real-time. According to an embodiment of the non-transitory computer-readable medium, the system utilizes a rule-based system to determine the aggregate factor.

FIG. 11 shows the block diagram of the cyber security module 1130 in view of the system and server according to an embodiment. The communication of data between the processor 1108 of system 1100 and the server 1170 through the communication module 1112 is first verified by the information security management module 1132 before being transmitted from the system to the server or from the server to the system. Cyber security module 1130 comprises information security management module 1132. The information security management module is operable to analyze the data for potential cyber security threats, to encrypt the data when no cyber security threat is detected, and to transmit the data encrypted to the system or the server. In an embodiment, the cyber security module further comprises an information security management module providing isolation between the system and the server. In an embodiment, the system comprises methods for securing the data through the cyber security module. The information security management module is operable to receive data from the communication module, exchange a security key at the start of the communication between the communication module and the server, receive a security key from the server, authenticate an identity of the server by verifying the security key, analyze the security key for potential cyber security threats, negotiate an encryption key between the communication module and the server, receive the encrypted data, transmit the encrypted data to the server when no cyber security threat is detected. In an embodiment, the system comprises decryption of data by the cyber security module according to an embodiment. In an embodiment, the system comprises methods for securing the data through the cyber security module. The information security management module is operable to receive data from the communication module, exchange a security key at a start of the communication between the communication module and the server, receive a security key from the server, authenticate an identity of the server by verifying the security key, analyze the security key for potential cyber security threats, negotiate an encryption key between the communication module and the server, receive encrypted data, decrypt the encrypted data, and perform an integrity check of the decrypted data, transmit the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module. In an embodiment, the server is physically isolated from the system through the information security management module. When the system communicates with the server as shown in FIG. 11, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model. The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-50. (canceled)

51. A system comprising,
one or more sensors, and a processor;
wherein the processor storing instructions in a non-transitory memory that, when executed, cause the processor to:
determine one or more of a probability of a road slippery condition at a geographic location and a confidence level on the probability using the sensors and in-vehicle road grip estimation module of a vehicle;
receive a first weighting factor based on a first data from a road condition estimation module for the geographic location;
receive a second weighting factor based on a second data from a climate module for the geographic location;
determine an aggregate factor based on the first weighting factor, and the second weighting factor; and
modify one or more of the probability of the road slippery condition and the confidence level on the probability based on the aggregate factor for the geographic location.

52. The system of claim 51, wherein the road condition estimation module comprises a road bump estimation module, a road damage estimation module, and a road construction map module; and wherein the first data is based on third data from the road bump estimation module, a fourth data from the road damage estimation module, and a fifth data from the road construction map module for the geographic location.

53. The system of claim 51, wherein the road condition estimation module and the climate module are located locally in the non-transitory memory of the vehicle or on a Cloud.

54. The system of claim 52, wherein the road bump estimation module comprises information about a road bump detail from one or more other vehicles; and wherein the road bump detail comprises one or more of bump size, number of bumps, and bump location.

55. The system of claim 52, wherein the road damage estimation module comprises information about a road damage detail from one or more other vehicles; and wherein the road damage detail comprises one or more of cracks, distribution of the cracks, size and shape of the cracks, potholes, distribution of the potholes, size and shape of the potholes.

56. The system of claim 52, wherein the road construction map module comprises information about a road construction detail from one or more of other vehicles, and one or more of road authority database, and road infrastructure database; and wherein the road construction detail comprises one or more of metal parts, construction completion level, and loose gravel.

57. The system of claim 51, wherein the climate module comprises information about a weather detail from one or more other vehicles; and wherein the weather detail comprises temperature, humidity, sunlight, cloud percent, and a first probability of rain, a second probability of snow, and a third probability of ice during a time period.

58. The system of claim 51, wherein the system further comprises a vehicle detail, wherein the vehicle detail comprises one or more of a brand, model, a make, and a weight class category of the vehicle.

59. The system of claim 51, wherein the system further considers a vehicle operating detail to determine the probability and the confidence level, wherein the vehicle operating detail comprises one or more of a speed, an acceleration or deceleration, a steering wheel position, and a brake force.

60. The system of claim 51, wherein the system further considers a driver behavior data to determine the probability and the confidence level, wherein the driver behavior data comprises an acceleration pattern, a braking pattern, a reaction time, and a steering behavior.

61. The system of claim 51, wherein the system further comprises one or more machine learning models aided by artificial intelligence; and wherein the machine learning models classify the road slippery condition based on one or more of vehicle parameters, wherein the vehicle parameters comprise one or more of a weight category, a tire tread, a tire width, a tire radius, a tread pattern, a tread depth, a tire pressure, a wheelbase, a suspension system, a braking force, a steering angle, a throttle position, and a drive type.

62. The system of claim 61, wherein the machine learning models are trained on historical data comprising a road condition data, a weather data, one or more of vehicle parameters, and driver behavior data; and wherein the machine learning models are configured to continuously learn and update as new data is collected, improving an accuracy of an estimate of the road slippery condition over time through adaptive algorithms.

63. The system of claim 51, wherein the system is further configured to communicate with one or more of a Cloud or other vehicles via a vehicle-to-vehicle (V2V) communication network to share an information about the road slippery condition; and wherein the system utilizes vehicle-to-infrastructure (V2I) communication to receive road condition updates from external sources, wherein the external sources comprise one or more of road sensors, and weather stations.

64. The system of claim 51, wherein the processor is configured to update the probability of the road slippery condition and the confidence level as new data is received in real-time.

65. The system of claim 51, wherein the geographic location is determined using Global Positioning System (GPS).

66. The system of claim 51, wherein the system utilizes crowdsourced data from multiple vehicles to refine an estimate of the road slippery condition in real-time.

67. A method comprising,
determining one or more of a probability of a road slippery condition at a geographic location and a confidence level on the probability using one or more sensors and in-vehicle road grip estimation module of a vehicle;
receiving a first weighting factor based on a first data from a road condition estimation module for the geographic location;
receiving a second weighting factor based on a second data from a climate module for the geographic location;
determining an aggregate factor based on the first weighting factor, and the second weighting factor; and
modifying one or more of the probability of the road slippery condition and the confidence level on the probability based on the aggregate factor for the geographic location.

68. The method of claim 67, wherein the method integrates with vehicle navigation systems to suggest alternative routes based on a current road slippery condition and a predicted road slippery condition; and wherein the method is configured to integrate with smartphone applications to provide drivers with notifications and alerts about road conditions before they start their journey.

69. A non-transitory computer-readable medium having stored thereon instructions executable by a computer system to perform operations comprising:
determining one or more of a probability of a road slippery condition at a geographic location and a confidence level on the probability using one or more sensors and in-vehicle road grip estimation module of a vehicle;
receiving a first weighting factor based on a first data from a road condition estimation module for the geographic location;
receiving a second weighting factor based on a second data from a climate module for the geographic location;
determining an aggregate factor based on the first weighting factor, and the second weighting factor; and
modifying one or more of the probability of the road slippery condition and the confidence level on the probability based on the aggregate factor for the geographic location.

70. The non-transitory computer-readable medium of claim 69, wherein the aggregate factor is based on a rule based system.
